(19) United States
(12) Patent Application Publication
(10) Pub. No.: US 2026/0236756 A1
(43) Pub. Date: Aug. 13, 2026

(54) Systems and Methods for Data Compression and Extraction

(71) Applicant: University of Maryland, College Park, College Park, MD (US)

(72) Inventors: Qiuyi Chen, Berwyn Heights, MD (US); Mark Fuge, College Park, MD (US)

(21) Appl. No.: 19/450,509

(22) Filed: Jan. 15, 2026

Related U.S. Application Data
(60) Provisional application No. 63/745,751, filed on Jan. 15, 2025.

(51) Int. Cl. G06N 3/0495

(52) U.S. Cl. CPC G06N 3/0495

(57) ABSTRACT

Systems, methods, apparatuses, and computer program products for data compression and extraction. A method may include receiving, at a computer device, input data from a data repository. The method may also include training, by the computer device, the ANN based on the input data. The method may further include compressing the input data into a latent space representation by implementing a least volume algorithm in the trained ANN. The method may also include dynamically reducing the latent space representation during the training of the ANN. The method may further include reconstructing, via the ANN, the input data based on the reduced latent space representation. The method may also include outputting the reconstructed input data from the ANN, wherein the input data may be reconstructed based on at least one reconstruction constraint.

### CROSS-REFERENCE TO RELATED APPLICATION

This application claims priority from U.S. provisional patent application No. 63/745,751 filed on Jan. 15, 2025. The contents of this earlier filed application are hereby incorporated by reference in their entirety.

### STATEMENT REGARDING FEDERALLY SPONSORED RESEARCH

This invention was made with government support in part by grant DE-AR0001216 awarded by the U.S. Department of Energy, and CMMI1943699 awarded by the National Science Foundation. The government has certain rights in the invention.

### FIELD

Some embodiments may generally relate to watermarking. For example, certain example embodiments may relate to apparatuses, systems, and/or methods for data compression and extraction.

### BACKGROUND

Learning data representation is important to machine learning (ML). for instance, on one hand, a good representation can distill the primary features from data samples, thus enhancing downstream tasks such as classification. On the other hand, when the data representation lies in a low-dimensional latent space Z and can be mapped backward to the data samples via some decoder g, it may be possible to facilitate generative tasks by training generative models in Z.

Often, a low dimensional Z is preferred. A real world dataset Xin a high dimensional data space X may reside on a low dimensional manifold. Thus, due to a rank theorem, X's low dimensionality may be inherited by its latent set [symbol] through an at least piecewise smooth and constant rank encoder e (i.e., [symbol] is low dimensional even if Z is high dimensional). Thus, for a [symbol] ⊂Z retaining sufficient information about X, a low dimensional Z may provide several advantages. For example, retaining sufficient information about X may result in improved efficacy of downstream tasks by aligning its latent dimensions more with the informative dimensions of [symbol] and alleviating the curse of dimensionality. In addition, it can increase the robustness of tasks such as data generation. Specifically, if a subset of U⊆ [symbol] constitutes an n-D manifold that can be embedded in an n-D Euclidean space, then due to the invariance of domain, U is open in Z as long as Z is n-D. This openness means that for a conditional generative model trained in such Z, if its one prediction \hat{z} is not far away from its target z∈U, then \hat{z} will also fall inside U⊆ [symbol] , thus still be mapped back into X by g rather than falling outside it.

Moreover, in the case where [symbol] is a manifold that cannot embed in similar dimensional Euclidean space, or where [symbol] is not even a manifold, retrieving the least dimensional Z needed to embed [symbol] may pave the way for studying the complexity and topology of [symbol] and X. Additionally, it may be desirable for the latent representation to indicate the amount of information for that each dimension has so that the data variations along the principal dimensions can be easily studied, and trade-offs can be easily made when it is necessary to strip off less informant latent dimensions due to computational cost.

In view of the above, there is a need for techniques and/or methodologies that can automatically learn both low-dimensional and importance-indicating nonlinear latent representation unrestricted to Euclidean data spaces. For example, there may be a need to introduce a least volume (LV) problem that provides a can compress the latent set into a low-dimensional latent subspace spanned by the latent space's standard basis.

### SUMMARY

Some example embodiments may be directed to a method of using an artificial neural network (ANN) to compress a latent space. The method may include receiving, at a computer device, input data from a data repository. The method may also include training, by the computer device, the ANN based on the input data. The method may further include compressing the input data into a latent space representation by implementing a least volume algorithm in the trained ANN. In addition, the method may include dynamically reducing the latent space representation during the training of the ANN. Further, the method may include reconstructing, via the ANN, the input data based on the reduced latent space representation. The method may also include outputting the reconstructed input data from the ANN. According to certain example embodiments, the input data may be reconstructed based on at least one reconstruction constraint.

Other example embodiments may be directed to an apparatus that uses an ANN to compress a latent space. The apparatus may include at least one processor and at least one memory storing instructions which, when executed by the at least one processor, cause the apparatus to at least receive input data from a data repository. The apparatus may also be caused to train the ANN based on the input data. The apparatus may further be caused to compress the input data into a latent space representation by implementing a least volume algorithm in the trained ANN. Further, the apparatus may be caused to dynamically reduce the latent space representation during the training of the ANN. In addition, the apparatus may be caused to reconstruct, via the ANN, the input data based on the reduced latent space representation. The apparatus may also be caused to output the reconstructed input data from the ANN. According to certain example embodiments, the input data may be reconstructed based on at least one reconstruction constraint.

Other example embodiments may be directed to an apparatus that uses an ANN to compress a latent space. The apparatus may include means for receiving input data from a data repository. The apparatus may also include means for training the ANN based on the input data. The apparatus may further include means for compressing the input data into a latent space representation by implementing a least volume algorithm in the trained ANN. In addition, the apparatus may include means for dynamically reducing the latent space representation during the training of the ANN. Further, the apparatus may include means for reconstructing, via the ANN, the input data based on the reduced latent space representation. The apparatus may also include means for outputting the reconstructed input data from the ANN. According to certain example embodiments, the input data may be reconstructed based on at least one reconstruction constraint.

In accordance with other example embodiments, a non-transitory computer readable medium may be encoded with instructions that may, when executed in hardware, perform a method of using an ANN to compress a latent space. The method may include receiving, at a computer device, input data from a data repository. The method may also include training, by the computer device, the ANN based on the input data. The method may further include compressing the input data into a latent space representation by implementing a least volume algorithm in the trained ANN. In addition, the method may include dynamically reducing the latent space representation during the training of the ANN. Further, the method may include reconstructing, via the ANN, the input data based on the reduced latent space representation. The method may also include outputting the reconstructed input data from the ANN. According to certain example embodiments, the input data may be reconstructed based on at least one reconstruction constraint.

Other example embodiments may be directed to a computer program product that performs a method of using an ANN to compress a latent space. The method may include receiving, at a computer device, input data from a data repository. The method may also include training, by the computer device, the ANN based on the input data. The method may further include compressing the input data into a latent space representation by implementing a least volume algorithm in the trained ANN. In addition, the method may include dynamically reducing the latent space representation during the training of the ANN. Further, the method may include reconstructing, via the ANN, the input data based on the reduced latent space representation. The method may also include outputting the reconstructed input data from the ANN. According to certain example embodiments, the input data may be reconstructed based on at least one reconstruction constraint.

### BRIEF DESCRIPTION OF THE DRAWINGS

For proper understanding of example embodiments, reference should be made to the accompanying drawings, wherein:

FIG. 1 illustrates an example flattening of the latent set via leave volume (LV), according to certain example embodiments.

FIG. 2 illustrates a pedagogical example of minimizing the L₁ regularizer, according to certain example embodiments.

FIG. 3 illustrates an example bar plot of latent dimension in LV problems, according to certain example embodiments.

FIG. 4 illustrates an example algorithm of LV autoencoder (AE) with DP, according to certain example embodiments.

FIG. 5 illustrates a comparison of methods that automatically reduce AE latent dimensions, according to certain example embodiments.

FIG. 6A illustrates an example reconstruction in 2D of LV on low dimensional toy problems, according to certain example embodiments.

FIG. 6B illustrates an example of latent space of LV on low dimensional toy problems, according to certain example embodiments.

FIG. 6C illustrates an example reconstruction in 3D of LV on low dimensional toy problems, according to certain example embodiments.

FIG. 6D illustrates an example projection along the Y-axis of LV on low dimensional toy problems, according to certain example embodiments.

FIG. 6E illustrates an example latent subspace 0-1 of LV on low dimensional toy problems, according to certain example embodiments.

FIG. 6F illustrates an example latent subspace 0-2 of LV on low dimensional toy problems, according to certain example embodiments.

FIG. 7A illustrates an example graphical depiction of latent set dimensionality vs L₂ reconstruction error, according to certain example embodiments.

FIG. 7B illustrates another example graphical depiction of latent set dimensionality vs L₂ reconstruction error, according to certain example embodiments.

FIG. 7C illustrates a further example graphical depiction of latent set dimensionality vs L₂ reconstruction error, according to certain example embodiments.

FIG. 7D illustrates yet another example graphical depiction of latent set dimensionality vs L₂ reconstruction error, according to certain example embodiments.

FIG. 8A illustrates an example graphical depiction of reconstruction vs latent dimension #, according to certain example embodiments.

FIG. 8B illustrates another example graphical depiction of reconstruction vs latent dimension #, according to certain example embodiments.

FIG. 8C illustrates a further example graphical depiction of reconstruction vs latent dimension #, according to certain example embodiments.

FIG. 8D illustrates yet another example graphical depiction of reconstruction vs latent dimension #, according to certain example embodiments.

FIG. 9 illustrates a table of embedding dimensions of modified national institute of standards and technology (MNIST) dataset and UIUC airfoils retrieved by least volume autoencoder trained with dynamic pruning (LVAE-DP), according to certain example embodiments.

FIG. 10A illustrates an example LV analysis of the MNIST dataset of the digit 2, according to certain example embodiments.

FIG. 10B illustrates an example LV analysis of a UIUC airfoil dataset, according to certain example embodiments.

FIG. 11A illustrates an example graphical depiction of a final latent dimension vs an initial latent dimension, according to certain example embodiments.

FIG. 11B illustrates an example graphical depiction of a relative reconstruction loss vs an initial latent dimension, according to certain example embodiments.

FIG. 12A illustrates an example of latent Gaussian samples produced by unregularized AEs with dim Z≈dim [symbol] , according to certain example embodiments.

FIG. 12B illustrates another example of latent Gaussian samples produced by unregularized AEs with dim Z≈dim [symbol] , according to certain example embodiments.

FIG. 13A illustrates an example graphical depiction of maximum mean discrepancy (MMD) between generated samples and true data samples, according to certain example embodiments.

FIG. 13B illustrates another example graphical depiction of MMD between generated samples and true data samples, according to certain example embodiments.

FIG. 13C illustrates a further example graphical depiction of maximum mean discrepancy (MMD) between generated samples and true data samples, according to certain example embodiments.

FIG. 13D illustrates an example relationship between a latent Gaussian samples' quality and latent space dimension, according to certain example embodiments.

FIG. 13E illustrates another example relationship between a latent Gaussian samples' quality and latent space dimension, according to certain example embodiments.

FIG. 13F illustrates a further example relationship between a latent Gaussian samples' quality and latent space dimension, according to certain example embodiments.

FIG. 13G illustrates yet another example relationship between a latent Gaussian samples' quality and latent space dimension, according to certain example embodiments.

FIG. 14A illustrates an example inspection of digit 9 latent set when dim Z=64>>dim [symbol] , according to certain example embodiments.

FIG. 14B illustrates another example inspection of digit 9 latent set when dim Z=64>>dim [symbol] , according to certain example embodiments.

FIG. 15A illustrates an example latent interpolation of LVAE-DP and unregularized AE in 2D latent subspaces, according to certain example embodiments.

FIG. 15B illustrates another example latent interpolation of LVAE-DP and unregularized AE in 2D latent subspaces, according to certain example embodiments.

FIG. 15C illustrates a further example latent interpolation of LVAE-DP and unregularized AE in 2D latent subspaces, according to certain example embodiments.

FIG. 15D illustrates yet another example latent interpolation of LVAE-DP and unregularized AE in 2D latent subspaces, according to certain example embodiments.

FIG. 16 illustrates an example LV analysis of MNIST, according to certain example embodiments.

FIG. 17A illustrates an example of latent Gaussian samples, according to certain example embodiments.

FIG. 17B illustrates an example of a latent code's distribution, according to certain example embodiments.

FIG. 18 illustrates an example of individual latent Gaussian samples of 10 digits, according to certain example embodiments.

FIG. 19 illustrates an example of LVDP-AE's reconstruction of CelebA images and the distribution of 110 latent σ, according to certain example embodiments.

FIG. 20A illustrates an example of samplings in the CelebA LVAE-DP's latent space, according to certain example embodiments.

FIG. 20B illustrates another example of samplings in the CelebA LVAE-DP's latent space, according to certain example embodiments.

FIG. 21A illustrates example interpolations in the CelebA LVAE-DP's latent space, according to certain example embodiments.

FIG. 21B illustrates another example of interpolations in the CelebA LVAE-DP's latent space, according to certain example embodiments.

FIG. 21C illustrates a further example of interpolations in the CelebA LVAE-DP's latent space, according to certain example embodiments.

FIG. 21D illustrates yet another example of interpolations in the CelebA LVAE-DP's latent space, according to certain example embodiments.

FIG. 22 illustrates an example of latent antipodes test results, according to certain example embodiments.

FIG. 23 illustrates an example of latent dimensions of a generalized least volume (GLV) AE of MNIST, according to certain example embodiments.

FIG. 24 illustrates an example distribution of MNIST digits in a GLV latent space, according to certain example embodiments.

FIG. 25A illustrates an example distribution of hierarchical density-based spatial clustering of applications with noise (HDBSCAN) clusters, according to certain example embodiments.

FIG. 25B illustrates an example distribution of contents of HDBSCAN clusters, according to certain example embodiments.

FIG. 26A illustrates an example distribution of HDBSCAN clusters with 100% labels, according to certain example embodiments.

FIG. 26B illustrates another example distribution of HDBSCAN clusters with 100% labels, according to certain example embodiments.

FIG. 26C illustrates an example distribution of HDBSCAN contents with 100% labels, according to certain example embodiments.

FIG. 26D illustrates an example distribution of HDBSCAN clusters with 50% labels, according to certain example embodiments.

FIG. 26E illustrates another example distribution of HDBSCAN clusters with 50% labels, according to certain example embodiments.

FIG. 26F illustrates an example distribution of HDBSCAN contents with 50% labels, according to certain example embodiments.

FIG. 26G illustrates an example distribution of HDBSCAN clusters with 10% labels, according to certain example embodiments.

FIG. 26H illustrates another example distribution of HDBSCAN clusters with 10% labels, according to certain example embodiments.

FIG. 26I illustrates an example distribution of HDBSCAN contents with 10% labels, according to certain example embodiments.

FIG. 26J illustrates an example distribution of HDBSCAN clusters with 2% labels, according to certain example embodiments.

FIG. 26K illustrates another example distribution of HDBSCAN clusters with 2% labels, according to certain example embodiments.

FIG. 26L illustrates an example distribution of HDBSCAN contents with 2% labels, according to certain example embodiments.

FIG. 27 illustrates an example of LV and GLV results on UIUC airfoils, according to certain example embodiments.

FIG. 28A illustrates an example distribution of LV and GLV latent codes of UIUC airfoils, according to certain example embodiments.

FIG. 28B illustrates another example distribution of LV and GLV latent codes of UIUC airfoils, according to certain example embodiments.

FIG. 28C illustrates a further example distribution of LV and GLV latent codes of UIUC airfoils, according to certain example embodiments.

FIG. 28D illustrates yet another example distribution of LV and GLV latent codes of UIUC airfoils, according to certain example embodiments.

FIG. 29 illustrates an example distribution of a normalized Jacobian spectral norm or local Lipschitz constant, according to certain example embodiments.

FIG. 30A illustrates an example distribution of GLV latent codes before and after optimization, according to certain example embodiments.

FIG. 30B illustrates another example distribution of GLV latent codes before and after optimization, according to certain example embodiments.

FIG. 30C illustrates a further example distribution of GLV latent codes before and after optimization, according to certain example embodiments.

FIG. 30D illustrates an example distribution of LV latent codes (scaled) before and after optimization, according to certain example embodiments.

FIG. 30E illustrates another example distribution of LV latent codes (scaled) before and after optimization, according to certain example embodiments.

FIG. 30F illustrates a further example distribution of LV latent codes (scaled) before and after optimization, according to certain example embodiments.

FIG. 30G illustrates yet another example distribution of LV latent codes (scaled) before and after optimization, according to certain example embodiments.

FIG. 30H illustrates an example distribution of GLV angle of attacks (AoAs) after optimization, according to certain example embodiments.

FIG. 30I illustrates an example distribution of LV AoAs after optimization, according to certain example embodiments.

FIG. 30J illustrates an example set of airfoil shapes before and after optimization, according to certain example embodiments.

FIG. 31 illustrates example plots of C_{L} and C_{D} after optimization, according to certain example embodiments.

FIG. 32A illustrates an example histogram of a Spearman's rank correlation of 1,000 test cases' optimization trajectories, according to certain example embodiments.

FIG. 32B illustrates an example histogram of cumulative regret of 1,000 test cases' optimization trajectories, according to certain example embodiments.

FIG. 32C illustrates an example histogram of mean deviation of 1,000 test cases' optimization trajectories, according to certain example embodiments.

FIG. 33 illustrates an example flow diagram of a method, according to certain example embodiments.

FIG. 34 illustrates an example apparatus, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for data compression and extraction.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments.

Additionally, if desired, the different functions or steps discussed below may be performed in a different order and/or concurrently with each other. Furthermore, if desired, one or more of the described functions or steps may be optional or may be combined. As such, the following description should be considered as merely illustrative of the principles and teachings of certain embodiments, and not in limitation thereof.

Mathematically, homeomorphism in general topology characterizes if a set [symbol] is a deformed replica of another set X. For instance, if X and [symbol] are topological spaces, a homeomorphism from X to [symbol] is a continuous bijective map f: [symbol] → [symbol] with continuous inverse. Thus, X and Z are homeomorphic to each other (denoted by [symbol] ≅ [symbol] ) if there is a homeomorphism between X and [symbol] . This enables embedding dimension of a dataset where a map f: [symbol] → [symbol] is called a topological embedding if its domain X is homeomorphic to its image f( [symbol] )⊆Z. An intrinsic dimension of a dataset X may be defined by dim [symbol] :=maxᵢ(dim [symbol] ⁱ). Its embedding dimension is the dimension m of the least dimensional Euclidean space [symbol] ^{m} to which a topological embedding φ: [symbol] → [symbol] ^{m}. Due to the topological invariance of dimension, intrinsic dimension embedding dimension.

According to certain example embodiments, the latent dimension of an autoencoder (AE) may be automatically reduced to the embedding dimension of the given dataset. If a continuous AE can reconstruct the dataset X perfectly, then its latent set [symbol] is a homeomorphic copy of the dataset X. The dataset may be an elastic curved surface in the high dimensional data space, and the latent set may be regarded as an intact “flattened” version of it tucked into the low dimensional latent space by the encoder. Thus, finding the least dimensional latent space may be a continuation of the flattening process in which the elastic latent surface is compressed onto latent hyperplanes of even lower dimensionality until it cannot be flattened anymore, reaching the embedding dimension of the dataset. Thus, according to certain example embodiments, it may be possible to extract the final hyperplane as the desired last dimensional latent space. In some example embodiments, a hyperplane that is either perpendicular or parallel to each latent coordinate axis may be extracted.

To flatten the latent set [symbol] and align it with the latent coordinate axes, it is desirable for the latent code's standard deviation (STD) vector σ( [symbol] ) to be as sparse as possible, which bespeaks the compression of the dataset onto a latent subspace of the least dimension. A penalty for promoting sparsity is the L₁ norm. However, ∥σ∥₁ does not necessarily lead to flattening.

In certain example embodiments, an alternative regularizer may include Πᵢσᵢ—the product of all elements of the latent code's STD vector σ, and this product may be referred to as the volume. This product may be based on the intuition that a curved surface can only be enclosed by a cuboid of much larger volume than a cuboid that encloses its flattened counterpart.

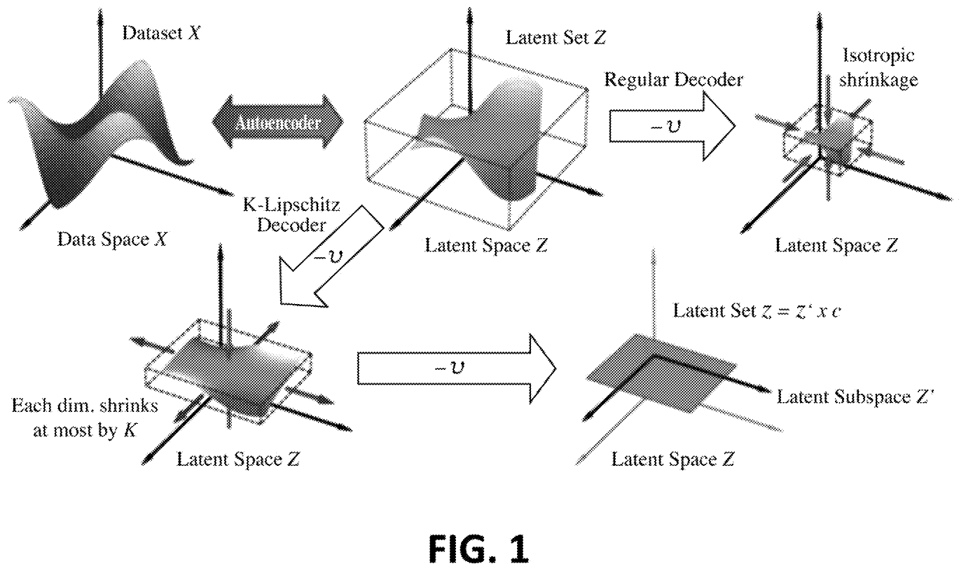

FIG. 1 illustrates an example flattening of the latent set via LV (“−v means reducing the cuboid's volume), according to certain example embodiments. As illustrated in FIG. 1, the cuboid has its sides parallel to the latent coordinate axes so that when the cuboid's volume is minimized, the flattened latent set inside is also aligned with these axes. Evaluating the cuboid's volume may include regarding the STD of each latent dimension as the length of each side of the cuboid. The cuboid's volume reaches zero only when one of its sides has zero length (i.e., σ₁=0), indicating that the latent surface is compressed into a linear subspace. The subspace may then be extracted as the new latent space, and the compression and extraction may continue recursively until the latent set cannot be compressed any more in the final latent space. As later discussed herein, this recursion may be realized with dynamic pruning (DP).

According to certain example embodiments, the latent STDs may be driven close to zero. This may occur when the elastic latent surface shrinks itself isotropically to shorten all of the enclosing cuboid's sides without further flattening the latent surface. To forestall this arbitrary shrinking that causes the trivial solution, the AE's latent set's elasticity may be regularized.

In certain example embodiments, the AE's latent set's elasticity may be regularized via the Lipschitz continuity of the decoder. The encoder may compress all latent STDs to almost zero. The decoder may scale up its network weights such that the small pertubations in the latent input still induce large enough output variations in the data space to achieve low reconstruction error. To do this, the decoder may include a large Lipschitz constant (K). If instead, the decoder had a small bounded Lipschitz constant, then any latent dimension with STD close to zero must also have close-to-zero variation in the data space due to the small K and, thus, correspond to a dimension perpendicular to the data surface. Additionally, a principal data dimension may retain a large variation in the latent space, as otherwise, the decoder may need to violate its bounded Lipschitz constant to achieve low reconstruction error. This bounded Lipschitz constant on the decoder may prevent the encoder from arbitrarily collapsing the latent codes to the trivial solution.

According to certain example embodiments, the volume preorder may be introduced over the non-negative orthant

$${ℝ}_{+}^{n}$$

to formalize the concept of volume minimization. The volume preorder may be defined as the letting the ith dimension of a vector a be denoted by aᵢ. The volume preorder ≲ is the binary relation on

$${ℝ}_{+}^{n}$$

defined by:

$$∀ \{ a , b \} ⊂ R + n , a ≾ b ⇔ ‖ a ‖ 0 < ‖ b ‖ 0 ⋁ ( ‖ a ‖ 0 = ‖ b ‖ 0 ⋀ ai > 0 \prod ai \leq bi > 0 \prod bi ) . \qquad ( 1 )$$

The LV problem may train an AE to achieve a latent set [symbol] with a STD vector σ that is minimized in terms of the volume preorder. Consequently, the optimal σ may not only have the least number of positive components, but also the least amount of volume Π_{σ}_{ᵢ}_{>0}σᵢ over its positive components. The former leads to dimension reduction and the latter to principal component analysis (PCA)-like importance ordering. Specifically, the LV problem of a continuous AE (e_{θ}, g_{θ}) with encoder e_{θ}:(X, ∥⋅∥₂)→(Z, ∥⋅∥₂) and decoder go: (Z, ∥⋅∥₂)→(X, ∥⋅∥₂) on a dataset [symbol] ⊆X is:

$$arg {min}_{Z} σ ( Z ) ∈ {ℝ}_{+}^{n} , ≾ \qquad ( 2 )$$

$$s . t . Z ∈ Z * := \{ Z = {e}_{\{ θ * \} ( X )} \vert θ * = arg {min}_{θ} {𝔼}_{\{ x ∼ X \}} {‖ {g}_{θ} ◦ {e}_{θ ( x )} - x ‖}_{2} \} \qquad ( 3 )$$

$$‖ g\_θ ( {z}_{1} ) - g\_θ ( {z}_{2} ) ‖ \_ 2 \leq K ‖ {z}_{1} - {z}_{2} ‖ \_ 2 , ∀ \{ {z}_{1} , {z}_{2} \} ⊆ Z ( X , {‖ \cdot ‖}_{2} ) {{\vec{←}}_{{g}_{θ}}}^{{e}_{θ}} ( Z , {‖ \cdot ‖}_{2} ) . \qquad ( 4 )$$

Here, σ( [symbol] ) is the latent set [symbol] 's STD to be minimized in terms of the volume preorder. Here, the L₂ reconstruction loss in (3) can be minimized to 0 when g_{θ}∘e_{θ}(x)=x for all xϵ [symbol] —as ∥g_{θ}∘e_{θ}(x)−x∥₂ is continuous with respect to xϵX and cl( [symbol] )=supp [symbol] d—in which case [symbol] is homeomorphic to [symbol] . This reconstruction constraint (3), together with the Lipschitz constraint on g_{θ} (4), prevents σ from collapsing to 0 trivially.

For any homeomorphism h, the new latent set h( [symbol] )=(h∘e_{θ})( [symbol] ), which is homeomorphic to [symbol] , is equivalent to [symbol] in the sense that g_{θ}∘e_{θ}(x)=(g_{θ}∘h⁻¹)∘(h∘e_{θ})(x). Therefore, as long as g_{θ} and e_{θ} have enough complexity to respectively represent g_{θ}∘h⁻¹ and h∘e_{θ} for a given set [symbol] of h, each homeomorphic latent set h( [symbol] ) with h∈ [symbol] must also be an optimal solution to the reconstruction problem, thus residing in Z*. Thus, the more complexity g_{θ} and e_{θ} have, the larger the set [symbol] is, thus a more complicated homeomorphism h can obtain to flatten [symbol] more sufficiently.

The volume Πᵢθᵢ of a latent set may be the square root of the diagonal product of the covariance matrix S of the latent codes. The square of the volume may correspond to the tight upper bound of the latent determinant det S, which is referred to as the Generalized Variance (GV). The square volume,

$${\prod }_{i} {θ}_{i}^{2}$$

is a tight upper bound of the latent determinant S. If det S is lower bounded by a positive value, then

$${\prod }_{i} {θ}_{i}^{2}$$

is minimized down to det Sif and only if Sis diagonal.

Here, the positive lower bound of det S is an unknown inherent constant determined by the dataset, and it may originate from the intuition that when the latent space reduces into the least dimensional one in which [symbol] cannot be flattened anymore, then det S cannot be zero, as otherwise it suggests [symbol] resides in a linear latent subspace and creates contradiction. Nor should det S be arbitrarily close to 0, as the K-Lipschitz decoder prevents degenerate shrinkage.

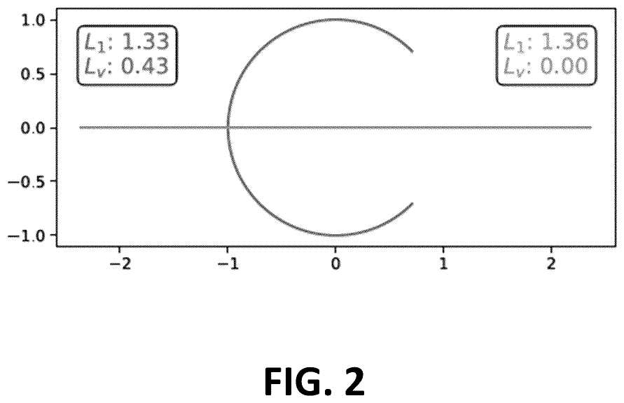

FIG. 2 illustrates a pedagogical example of minimizing the L₁ regularizer, according to certain example embodiments. As illustrated in FIG. 2, only the volume Πᵢθᵢ correctly tells the line [symbol] ᵢ is flatter. As also illustrated in FIG. 2, the L₁ regularizer is minimized to produce less flattened representations than minimizing the volume. Here, “L₁” refers to ∥σ∥₁ and “Lᵥ” refers to Πᵢθᵢ. The example of FIG. 2 may be used to show that the volume is better than L₁-based regularizers in terms of determining the sparsity of σ (i.e., how flat the latent set is). FIG. 2 illustrates a straight line [symbol] ₗ of length

$$\frac{3}{2} π$$

and a blue arc [symbol] ₐ of the same length. There exists an isometry h: [symbol] ₗ→ [symbol] ₐ. If the arc is a latent set created through [symbol] ₐ=e( [symbol] ), then [symbol] ₗ=h⁻¹∘e( [symbol] ) is an equivalently good one, provided that the encoder e has enough complexity to learn h⁻¹∘e. Moreover, because the isometry h is 1-Lipschitz, then a K-Lipschitz decoder g with enough complexity can also learn g∘h since this is also K-Lipschitz, so both [symbol] ₗ and [symbol] ₐ are latent sets that can be produced by e and g with enough complexity.

According to certain example embodiments, enhancing the flattening process may include ensuring that the AE has good reconstruction performance over the dataset, such that the latent set is a low-dimensional replica of the dataset that preserves useful topological information. The continuity of the AE may preserve the dataset's structure. For example, a continuous AE (e, g) between the data space X= [symbol] ⁿ and the latent space Z= [symbol] ⁿ with the norm-based reconstruction error [symbol] _{x~} [symbol] ∥g∘e(x)−x∥=0 learns a topological embedding of the dataset [symbol] . In other words, the latent set [symbol] =e( [symbol] )⊆Z is a homeomorphic copy of the dataset.

Since [symbol] is a homeomorphic copy of [symbol] , [symbol] 's important topological properties like connectedness and compactness—which are invariant under homeomorphism—are preserved on [symbol] . This means that if some of these invariant properties are the only information relied upon when analyzing [symbol] has, or evaluate its local dimensionality, then it may be possible to derive the same results from [symbol] . Additionally, [symbol] may become more efficient to analyze if it resides in a low-dimensional linear subspace that is easy to extract.

If the errorless AE's latent set has the form [symbol] ═ [symbol] ′×c, where c∈ [symbol] ^{p} is a constant and [symbol] ⊆Z′= [symbol] ^{m-p}, then π∘e| [symbol] is also a topological embedding of [symbol] , where π:Z′×c [symbol] z′×c→z′∈Z′ is the projection map. This expression suggests that if the errorless AE's latent set is forced to assume such a form while increasing the vector c's dimension p as much as possible, a latent space that is the lowest dimensional Euclidean space may be obtained that can still correctly embed the dataset. If achieved, the resulting low-dimensional latent space is not only more efficient to analyze, but also provides useful information about the topology of [symbol] . For instance, not every smooth m dimensional manifold can be embedded in [symbol] ^{m}. Thus, if [symbol] is a smooth manifold, then obtaining the least dimensional Z through a smooth AE may provide a lower bound of [symbol] 's intrinsic dimensionality.

In certain example embodiments, the AE's ideal everywhere-errorless-reconstruction may be enforced by minimizing the reconstruction error ϵ= [symbol] ∥g∘e(x)−x∥, yet due to inevitable numerical errors and data noise that should be ignored by the AE reconstruction, ϵ cannot strictly reach zero after optimization. Likewise, during volume reduction, numerically the latent set cannot strictly take the form as described above, but rather only at best has marginal STDs in several latent dimensions. Intuitively, the latent set may be considered as flattened into a thin plane and the nearly-constant latent dimensions may be discarded to obtain a latent set of lower dimensionality with π, in order to continue the recursive volume minimization.

According to certain example embodiments, a latent set [symbol] may have several STDs close to zero after numerical optimization. Although such [symbol] is not exactly in the form of [symbol] ′×c to apply π, the latent dimensions of marginal STDs may still be regarded as trivial in the sense that pruning them (i.e., fixing their value at their mean—will not include much difference to the decoder g's reconstruction, provided that g's Lipschitz constant is not large). The pruned [symbol] = [symbol] ′×c and can be fed to π to extract [symbol] ′. The inverse π⁻¹ helps map [symbol] ′ back into the data space through g∘π⁻¹ without inducing large reconstruction error. This theorem supports having Lipschitz continuous decoder for learning a compressed latent subspace—for small K, a latent dimension of near-zero STD cannot correspond to a principal dimension of the data manifold. In contrast, in the absence of this constraint, the decoder may learn to scale up K to align near-zero variance latent dimensions with some of the principal dimensions.

In certain example embodiments, minimizing the volume may be disentangled from reducing the reconstruction loss, at least for a linear case. Specifically, the reconstruction loss may control P, while the last volume regularization controls the rotation and scaling in the latent space respectively through U, Q, and Σ. The product UΣQ^{T} then models the family [symbol] of linear homeomorphisms that the linear AE (without bias vectors) can additionally learn beyond preserving information through P^{T}. The linear encoder may be in the form of A=(UΣQ^{T})∘P^{T} while the linear decoder is in the form of B=P∘QΣ⁻¹U^{T}=P∘(UΣQ^{T})⁻¹.

Due to the minimization of volume, Z ends up being an identity matrix, making both g and e isometric over dataset X. This means e does not scale up or down any data dimension in the latent space. Additionally, the rotations U and Q help fit as much data information into the most primary latent dimensions as possible, such that when any number of the least informant latent dimensions is removed, the remaining dimensions still store the most amount of information they can extract from X in terms of minimizing the reconstruction loss. For nonlinear AEs, a cramming effect that is similar yet not identical may be expected because after stripping off some least informant latent dimensions, the nonlinear AE may further reduce the reconstruction loss by curling up the decoder's image—now of lower dimension—in the dataset to traverse more data region.

According to certain example embodiments, the ordering effect of PCA (i.e., the magnitude of each latent dimension's variance indicates each latent dimension's degree of importance) is at least partially a result of reducing the latent determinant until the singular values of B reach their upper bound 1, such that g becomes isometric and preserves distance. This means that e is not allowed to scale up the dataset X along any direction in the latent space if it is unnecessary, as it may increase the latent determinant and, thus, the volume. Thus, it may be possible to minimize the volume or any other sparsity penalties to hinder this unnecessary scaling by the encoder e, given that it increases the penalty's value. This suggests that the latent dimension's importance in the data space may in general scale with its latent STD.

In certain example embodiments, the LV may induce a similar importance ordering effect for nonlinear AEs, and each latent dimension may be quantified to determine its importance. This may be done by generalizing the variance used for PCA. For instance, for PCA, the variance may measure the contribution of each latent dimension in minimizing the mean squared error (MSE) reconstruction error

$$𝔼 ‖ x - \hat{x} {‖}_{2}^{2}$$

as a percentage. Since for a nonlinear model the identity [symbol] ({i})= [symbol] ({i,j}) generally does not hood, there is no reason to stick with the MSE. It may then natural to extrapolate [symbol] and ε to the nonlinear case by generalizing

$${ε}_{{‖ \cdot ‖}_{2}^{2}} ( P )$$

to ε_{D}(P) (i.e., the induced reconstruction error with respect to the metric D after pruning dimensions in P:

$${ε}_{D} ( P ) = 𝔼 [ D ( {\tilde{x}}_{P} , x ) ] - ϵ = 𝔼 [ D ( {\tilde{x}}_{P} , x ) ] - 𝔼 [ D ( \hat{x} , x ) ] . \qquad ( 5 )$$

Then [symbol] _{D} (P) the explained reconstruction of latent dimensions in P with respect to metric D—can be defined as [symbol] _{D}(P)=ε_{D}(P)/ε_{D}(Ω).

Although the LV problem provides a start for retrieving a least dimensional representation [symbol] of a given dataset [symbol] , the formulation is derived based on the assumption that both the latent space Z and the data space X are equipped with Euclidean distances. After solving such a problem, if a given latent dimension has a large σᵢ, it means that the data variation it controls is important with respect to the Euclidean distance, but a X equipped with some more meaning metrics (e.g., perceptual metric on images, performance-aware metric on a set of mechanical designs such as an airfoil). In addition, the LV problem is designed for an unlabeled dataset. For a labeled dataset, incorporating the label information in training may help derive a more useful representation for different downstream tasks (e.g., transfer learning). Thus, according to certain example embodiments, it may be possible to provide a generalized least volume (GLV) that for applications in which the metrics d_{Z} and d_{X} of the latent space Z and the data space X are not L₂ distances, it may be possible to first transform them into L₂ metric spaces via isometries—the distance-preserving maps—then apply LV equivalently between L₂ spaces, and eventually transform the result back to the original metric spaces via isometries again. This transformation may naturally provide the ability to deal with labelled datasets, and the labels may be readily incorporated into the GLV formulation when the data metric d_{X} is informed by the labels.

According to certain example embodiments, isometries may allow for the generalization of LV problems to data spaces and latent spaces of metrics other than L₂ distance. Such LV problems may generally be referred to as GLV problems to emphasize their distinction from regular LV problems between L₂ spaces. According to some example embodiments, it may be possible to transform a GLV problem between two arbitrary metric spaces into an equivalent one between a different pair of metric spaces using isometries.

For an AE (e_{θ}, g_{θ})_{(X,d}_{ₓ}_{)↔(z,d}_{_{z}}₎, its GLV problem over the dataset [symbol] ⊆X is defined as:

$$arg {min}_{𝒵} σ ( 𝒵 ) \qquad ( 6 )$$

$$s . t . 𝒵 ∈ {𝒵}^{⋆} := \{ \tilde{𝒵} = {e}_{{θ}^{⋆}} ( 𝒳 ) \vert {θ}^{⋆} = arg {min}_{θ} {𝔼}_{x ∼ 𝒳} {d}_{X} ( {g}_{θ} ◦ {e}_{θ} ( x ) , x ) \} \qquad ( 7 )$$

$${d}_{X} ( {g}_{θ} ( {z}_{1} ) , {g}_{θ} ( {z}_{2} ) ) \leq {Kd}_{Z} ( {z}_{1} , {z}_{2} ) , ∀ \{ {z}_{1} , {z}_{2} \} ⊆ Z . \qquad ( 8 )$$

It has the equivalent formulation below on another AE (\tilde{e}_{θ},\tilde{g}_{θ})_{(\tilde{x},d}_{_{\tilde{X}}}_{)↔(\tilde{z},d}_{_{\tilde{Z}}}₎ between a different pair of metric spaces \tilde{X} and \tilde{Z} on the transformed dataset \tilde{X}:=φ( [symbol] ), provided that it may be possible to find the isometries ψ:Z→\tilde{X} that makes Z≈\tilde{Z} and X≈φ(X):

$$arg {min}_{𝒵 = {ψ}^{- 1} ( \tilde{𝒵} )} σ ( 𝒵 ) \qquad ( 9 )$$

$$s . t . \tilde{𝒵} ∈ {𝒵}^{⋆} := \tilde{𝒵} = {\overline{e}}_{( {θ}^{⋆} )} ( \tilde{𝒳} ) \vert {θ}^{⋆} = arg {min}_{θ} {𝔼}_{( \tilde{x} ∼ \tilde{𝒳} )} {d}_{( \tilde{𝒳} )} ( {\hat{g}}_{θ} ◦ {\overline{e}}_{θ} ( \tilde{x} ) , \tilde{x} ) \qquad ( 10 )$$

$$( 15 ) {d}_{( \tilde{𝒳} )} ( {\hat{g}}_{θ} ( {\tilde{z}}^{1} ) , {\hat{g}}_{θ} ( {\tilde{z}}^{2} ) ) \leq K \cdot {d}_{( \tilde{𝒵} )} ( {\tilde{z}}^{1} , {\tilde{z}}^{2} ) , ∀ {\tilde{z}}^{1} , {\tilde{z}}^{2} ⊆ \tilde{𝒵} . \qquad ( 11 )$$

According to certain example embodiments, for the GLV problem on the AE (\tilde{e}_{θ},\tilde{g}_{(x,d}_{_{X}}_{)↔z} over the dataset [symbol] ⊆X where dₓ:=φ*d_{\tilde{X}} is the pullback metric induced by the topological embedding φ:(X, ∥⋅∥₂)→(\tilde{X}, ∥⋅∥₂), it has the equivalent formation below on the (generalized) AE ((e_{θ}, \tilde{g}_{θ})_{(X, ∥⋅∥}_{₂}_{)→Z→\tilde{X}}:

$$arg {min}_{𝒵} σ ( 𝒵 ) \qquad ( 12 )$$

$$s . t . 𝒵 ∈ {𝒵}^{⋆} := 𝒵 = {e}_{( {θ}^{⋆} )} ( 𝒳 ) \vert {θ}^{⋆} = arg {min}_{θ} {𝔼}_{( x ∼ 𝒳 )} {‖ {\tilde{g}}_{θ} ◦ {e}_{θ} ( x ) - ϕ ( x ) ‖}_{2} \qquad ( 13 )$$

$${‖ {\tilde{g}}_{θ} ( {z}_{1} ) - {\tilde{g}}_{θ} ( {z}_{2} ) ‖}_{2} \leq K {‖ {z}_{1} - {z}_{2} ‖}_{2} , ∀ {z}_{1} , {z}_{2} ⊆ 𝒵 . \qquad ( 14 )$$

After training, if needed, another model f_{θ} may be trained to approximate φ̅⁻¹ and, thus, obtain the K-Lipschitz g_{θ}:Z→(X, d_{X})=f_{θ}∘\tilde{g}_{θ}, albeit often the encoder e_{θ} and the representation [symbol] may be more applicable. Here, φ:(X, ∥⋅∥₂)→\tilde{X}) must be homeomorphic onto its image, as otherwise it may happen that ( [symbol] , d_{X})≈( [symbol] , ∥⋅∥₂).

According to certain example embodiments, the labeled GLV may be in L_{∞} product metric space. In this example embodiment, it may be assumed that \tilde{X}= [symbol] (ƒ|ₓ) is a labeled dataset where the label function ƒ is continuous. For the AE (\tilde{e}_{θ}, \tilde{g}_{θ})_{(X,d}_{_{X}}_{)↔Z} where dₓ=φ* [symbol] _{∞} is the label-informed pullback induced by φ:(X, ∥⋅∥₂)→(X×Y, [symbol] _{∞-}=idₓ×ƒ, its GLV problem over the unlabeled dataset [symbol] has the equivalent formulation below on the AE (e_{θ}, \tilde{g}_{θ}) [symbol] over the labeled dataset \tilde{X}, where

$${\overline{g}}_{θ} := {g}_{θ}^{x} \times {g}_{θ}^{y}$$

with

$${g}_{θ}^{x} \text{:} Z \to ( X , {‖ \cdot ‖}_{2} ) and {g}_{θ}^{y} \text{:} Z \to ( Y , {‖ \cdot ‖}_{2} ) :$$

$$arg {min}_{𝒵} σ ( 𝒵 ) \qquad ( 15 )$$

$$( 16 )$$

$$s . t . 𝒵 ∈ {𝒵}^{⋆} := 𝒵 = {e}_{( {θ}^{⋆} )} ( 𝒳 ) \vert {θ}^{⋆} = arg {min}_{θ} {𝔼}_{( ( x , y ) ∼ \tilde{𝒳} )} {‖ {\tilde{g}}_{θ} ◦ {e}_{θ} ( x ) - ( x , y ) ‖}_{2}$$

$$∀ {z}_{1} , {z}_{2} ∈ 𝒵 , {‖ {g}_{θ}^{x} ( {z}^{1} ) - {g}_{θ}^{x} ( {z}^{2} ) ‖}_{2} \leq K {‖ {z}^{1} - {z}^{2} ‖}_{2} \qquad ( 17 )$$

$${‖ {g}_{θ}^{y} ( {z}^{1} ) - {g}_{θ}^{y} ( {z}^{2} ) ‖}_{2} \leq K {‖ {z}^{1} - {z}^{2} ‖}_{2} .$$

As shown above, (17) is equivalent to ma x

$$( {‖ {g}_{θ}^{x} ( {z}_{1} ) - {g}_{θ}^{x} ( {z}_{2} ) ‖}_{2} , \\ {‖ {g}_{θ}^{y} ( {z}_{1} ) - {g}_{θ}^{y} ( {z}_{2} ) ‖}_{2} ) \leq K {‖ {z}_{1} - {z}_{2} ‖}_{2} .$$

Moreover, because the [symbol] topology equals the product topology, φ is still a topological embedding, while

$${g}_{θ}^{x} : Z \to ( X , {‖ \cdot ‖}_{2} ) and {g}_{θ}^{y} : Z \to ( Y , {‖ \cdot ‖}_{2} )$$

being continuous makes \tilde{g}_{θ}:Z→(X×Y, [symbol] _{∞}) continuous. At last, the [symbol] ₂ loss in (16) can replace [symbol] _{∞}, as they both make g_{θ}∘e_{θ}(x)=(x, y) when reaching zero.

The volume Π_{σ}_{ᵢ}_{>0}σᵢ may be evaluated over latent dimensions with σᵢ( [symbol] )>>0 and ignore the dimensions with σᵤ( [symbol] )≅0, but the unary relations >>0 and ≅0 are not well-defined. Thus, certain example embodiments may provide ways for obtaining approximate solutions of LV problems—the simpler volume penalty and the more reliable volume minimization with dynamic pruning.

According to certain example embodiments, it may be possible to circumvent the recursive process by resorting to the weighted sum:

$$L = J + λ \cdot {L}_{η}^{vol} = J + λ \cdot \sqrt[n]{{\prod }_{i} ( {σ}_{i} ( Z ) + η )} . - \qquad ( 18 )$$

Equation (18) may be implemented to perform the constrained optimization approximately, where J is the reconstruction loss. In performing the constrained optimization,

$${L}_{vol}^{η}$$

represents the volume penalty augmented with a hyperparameter ρ>0 that mitigates the vanishing gradient when σᵢ( [symbol] )≈0, n denotes dim Z, and λ is the weight coefficient making the trade-off between the reconstruction quality and the degree of volume reduction.

$${L}_{vol}^{η}$$

may be evaluated using the ExpMeanLog trick to avoid numerical issues.

In certain example embodiments, minimizing the penalty equivalently minimizes an upper bound of the volume and naturally interpolates between

$$\sqrt[n]{{\prod }_{i} {σ}_{i}} and \frac{1}{n} {‖ σ ‖}_{1}$$

gradient-wise, given that as η→∞:

$$\begin{matrix}{∇}_{θ} ( {( \prod ( {σ}_{i} + η ) )}^{\frac{1}{n}} ) = ( \frac{1}{n} ) {\sum }_{i} ( \frac{{( \prod ( {σ}_{i} + η ) )}^{\frac{1}{n}}}{( {σ}_{i} + η )} ) {∇}_{θ} {σ}_{i} \to ( \frac{1}{n} ) {\sum }_{i} {∇}_{θ} {σ}_{i} \\ = {∇}_{θ} ( ( \frac{1}{n} ) {‖ σ ‖}_{1} ) .\end{matrix} \qquad ( 19 )$$

With equation (19) it may be possible to seamlessly shift from volume penalty to L₁ penalty by increasing η. It can be seen that the lower the η, the more the regularizer's gradient prioritizes minimizing smaller σᵢ, which intuitively should make σ sparser than the L₁ penalty does that scales every ∇_{θσ}_{ᵢ} equally.

The volume penalty

$${L}_{vol}^{η} = \sqrt[n]{{\prod }_{i} ( {σ}_{i} ( Z ) + η} ) -$$

is straightforward to evaluate, but it incurs several drawbacks. First, the hyperparameter η≥0 is introduced to overcome the vanishing gradient issue caused by the group of σᵢ≈0 that emerge as

$$\sqrt[n]{{\prod }_{i} {σ}_{i} ( ℨ )}$$

decreases, which stagnates ∥σ( [symbol] )∥₁ and the ∥σ∥₀'s reduction. η helps

$${L}_{vol}^{η}$$

interpolate between

$$\sqrt[n]{{\prod }_{i} ( {σ}_{i} ( ℨ ) + η )}$$

and

$$\frac{1}{n} {‖ σ ( \text{?} ) ‖}_{1}$$

gradient-wise. Thus, by setting a large enough η, it may be possible
to provide those latent dimensions of large σᵢ with enough gradient to keep compressing themselves to reduce ∥σ∥₀ further. However, it may be challenging to determine whether an η is large enough without some heuristic determination. In addition, when η>0, minimizing

$${L}_{vol}^{η}$$

is not equivalent to minimizing the actual volume Πᵢσᵢ( [symbol] ). As η increases,

$${L}_{vol}^{η}$$

behaves more like ∥σ( [symbol] )∥₁ and the ∥σ∥₀ reduction performance deteriorates.

Additionally,

$${L}_{vol}^{η}$$

minimization may be a makeshift for the conceptual recursion of subspace compression and extraction. Without the recursive removal of the dummy latent dimensions with σᵢ≈0, performing the volume reduction in the whole n-D latent space may be needed, and it may also be necessary to keep compressing those already annihilated dummy dimensions, rather than only focusing on those dimensions with σᵢ>>0. This rigidity causes the dimension reduction result of the volume minimization to depend on the choice of the latent space dimension n, and to stagnate especially when n significantly exceeds the dataset's embedding dimension.

Certain example embodiments may implement a DP algorithm to reduce the actual volume penalty Lᵥₒₗ:=

$${L}_{vol} := \sqrt[\vert x \vert]{{Π}_{i ϵ ℶ} {θ}_{i} ( \text{?} )} ,$$

which may be evaluated on the set of non-trivial latent dimensions I:={i|σᵢ( [symbol] )>>0} to reduce σ with respect to the volume preorder ≲. Here, in I, >>0 is used instead of the >0 because σᵢ cannot be made to strictly zero. A new training loss may be provided as shown below when Lᵥₒₗ replaces

$${L}_{vol}^{n}$$

in equation (18).

$$L = J + λ \cdot {L}_{vol} = J + λ \cdot \sqrt[\vert X \vert]{{\prod }_{i ε 𝒥} {σ}_{i} ( Z )} . - \qquad ( 20 )$$

According to certain example embodiments, DP may be configured to dynamically prune out the annihilated latent dimensions (i.e., latent dimensions with σᵢ, ≈0—when the loss is minimized during the training of AEs so that the set of indices I:={i|σᵢ( [symbol] )>>0} stays updated for extracting the least dimensional latent space [symbol] := [symbol] Zᵢ, where the flattened [symbol] currently lies. Thus, the kernel of DP may be a criterion against which a determination can be made as to whether a given latent dimension satisfies σᵢ, ≈0 rather than σᵢ, >>0 and, thus, should be removed from I.

Setting a small threshold δ>0 for σᵢ to determine if σᵢ≈0 (⇔σᵢ<δ) can be a viable strategy. The length scale of [symbol] may vary across different datasets and AEs, and may also consistently change throughout the training process. Thus, a constant threshold δ that reasonably indicates small σᵢ values in one setting may fail in another setting. Accordingly, it may be necessary to make ≈0 and >>0 independent of [symbol] 's length scale.

According to certain example embodiments, a length-scale-independent ρ-criterion may be built based on the LV problem. For example, for the LV problem on every dataset being tested, after minimizing the volume

$${\prod }_{i = 1}^{n} = {σ}_{i} ( Z ) -$$

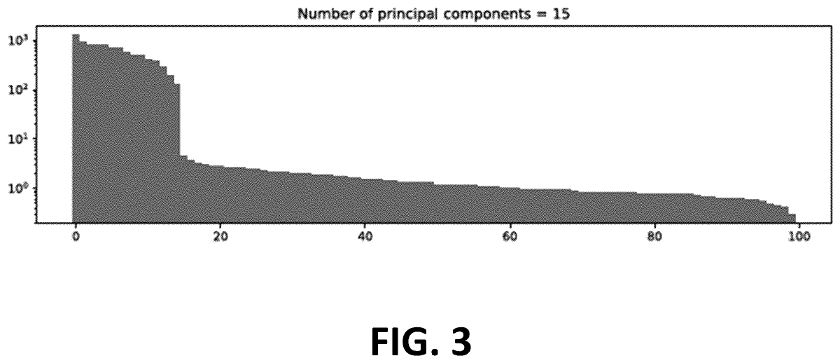

over the entire n-D latent space, if all latent dimensions are reindexed with respect to σᵢ( [symbol] ) in descending order—such that σᵢ≥σⱼ for I<j—then plot them out in a bar plot and put the y-axis on a log scale, there may be a noticeable plummet right after a given index k, as illustrated in FIG. 3. That is, the k is the index where σᵢ/σᵢ₊₁ is the greatest. Most latent dimensions after dimension k can be regarded as trivial, given their orders of magnitude smaller σᵢ relative to σₖ, and empirically also much lower influence on the reconstruction error when pruned. Thus, after retrieving k, the relative magnitude σᵢ/σₖ may be used to determine if σᵢ≈0.

In certain example embodiments, after specifying δ>0 and permuting σϵ

$${ℝ}_{+}^{n}$$

into [symbol] such that [symbol] ᵢ≥ [symbol] for I<j, the unary relations ≈0 and >>0 on σᵢ may be defined as:

$${σ}_{i} \approx 0 ⇔ ¬ ( {σ}_{i} ≫ 0 ) ⇔ {ρ}_{i} := \frac{{σ}_{i}}{{ς}_{k}} < δ where k = {argmax}_{i} ( \frac{{ς}_{i}}{{ς}_{i + 1}} ) . \qquad ( 21 )$$

After I is determined along with its complement I^{C}, the pruning operator pₚ may be defined as Z→Z_{I}×z̅_{I}c by

$${[ {p}_{p} ( z ) ]}_{i} = \{ \begin{matrix}{z}_{i} & i ∈ I \\ {\overline{z}}_{i} & i ∈ {I}^{c}\end{matrix}$$

together with the projection π:Z_{I}×z_{I}c→Z_{I}, where each element z̅_{I}c equals the mean μᵢ( [symbol] ) frozen at the moment when I is included in I^{C}. The AE (π∘pₚ∘e_{θ}, g_{θ}π⁻¹) is then the desired one mapping between the data space X and the least dimensional latent space Z_{I}. Here, pₚ:Z→Z_{I}×z̅_{I}c and π⁻¹:Z_{I}→Z_{I}×z̅_{I}c allows the ability to ignore the trivial dimensions i in I^{C} when training e_{θ}, since all of them only outputs and intakes the constant z̅₁ by construction once included in I^{C}. For simplicity, when discussing the LV AEs trained with DP (LVA-DPs), e_{θ} and g_{θ} may be used to refer to π∘pₚ∘e_{θ} and g_{θ}∘π⁻¹, and Z may refer to Z_{I}, unless otherwise specified.

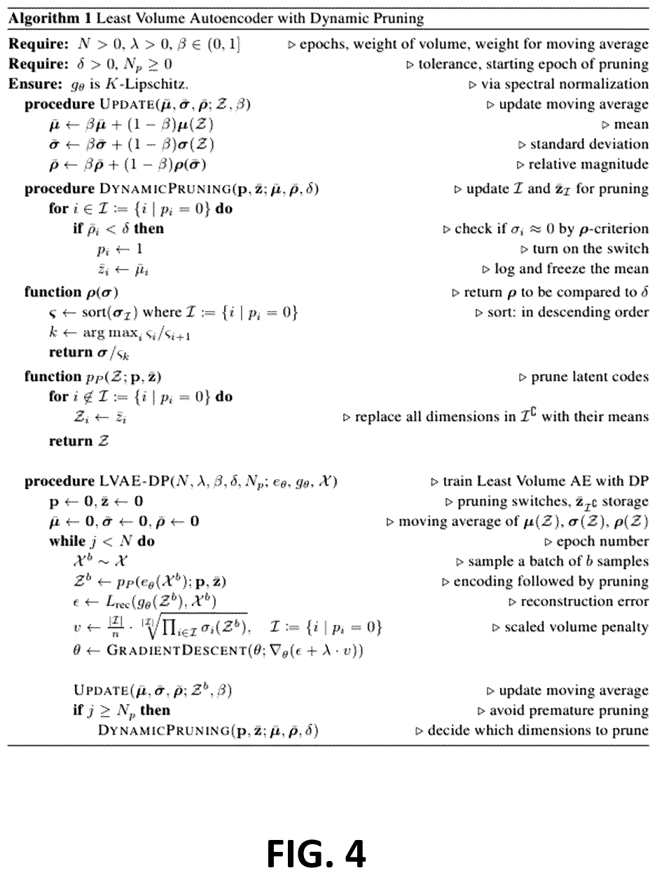

FIG. 4 illustrates an example algorithm of LV AE with DP, according to certain example embodiments. AS illustrated in FIG. 4, AEs may be trained with a mini-batch gradient descent by first introducing the update procedure to track the moving average of μ, σ, and ρ of [symbol] over the mini-batch [symbol] ^{b} to estimate their ground truth values. The hyperparameter β may be set to 0.9 to mitigate the disturbance caused by outliers. The DP algorithm updates I based on the ρ-criterion may use z̅ to record the frozen mean values μᵢ of the to-be-pruned trivial latent dimensions. The pruning function pₚ may use the up-to-date I and z̅ to prune the latent set.

In certain example embodiments, the volume penalty Lᵥₒₗ may be scaled with the factor

$$\frac{\vert I \vert}{n}$$

to unify the magnitude of Lᵥₒₗ's gradient throughout pruning, given that

$${∇}_{θ} \sqrt[\vert x \vert]{{\prod }_{i} {σ}_{i} = \frac{1}{\vert x \vert}} {\sum }_{i} \frac{\sqrt[\vert x \vert]{{\prod }_{i} {σ}_{i}}}{{σ}_{i}} \cdot {∇}_{θ} {θ}_{i} .$$

The threshold parameter δ is by default set to 2%. Increasing the threshold parameter δ may lead to a more aggressive removal of the trivial latent dimensions. This may be useful if the dataset is noisy, as it may help to remove many latent dimensions that only correspond to meaningless noise. Removing trivial latent dimensions may not noticeably affect the reconstruction error J. This allows the algorithm of FIG. 4 to proceed seamlessly (i.e., without suspending volume reduction to counteract a surge in reconstruction loss.

According to certain example embodiments, the Lipschitz continuity in the constraints described herein may be enforced via spectral normalization such as, for example, by normalizing the spectral norm of all linear layers to 1. The Lipschitz constant may also be enforced through gradient regularization based on the decoder's Jacobian-vector product. Combining these spectrally normalized linear layers with 1-Lipschitz activation functions such as LeakyReLU and Sigmoid the constant K can be prevented from exceeding 1. If it is needed to select a K≠1—for instance, to facilitate the reconstruction error reduction on a dataset of large length scale—it may be possible to adjust it by attaching a pointwise scaling function h(x)=K·x to the 1-Lipschitz decoder g and turn it into g_{new}=g∘h.

In general, the latent set may be encouraged to be low dimensional via sparse coding, which may apply sparsity penalties such as least absolute shrinkage and selection operator (LASSO) over the latent code vector to induce as many zero-features as possible. However, a latent representation transformed by a homeomorphism h is equivalent to the original in the sense that g_{θ}∘e_{θ}(x)=(g_{θ}∘h⁻¹)∘(h∘e)(x). Thus, translating the sparse-coding latent set arbitrarily—which makes the zero-feature no longer zero—may provide an equally good representation.

This equivalent latent set may be one that has zero-STDs along many latent dimensions. However, h may not be restricted to translation. For instance, rotation may also be homeomorphic and, thus, rotating the flat latent set can also give an equivalently good representation. Implicit rank-minimizing autoencoder (IRMAE) may be regarded as a case in which the latent set is compressed into a linear subspace not necessarily aligned with the latent coordinate axes. There may also be stochastic methods such as K-sparse AE that compresses the latent set by randomly dropping out inactive latent dimensions during training.

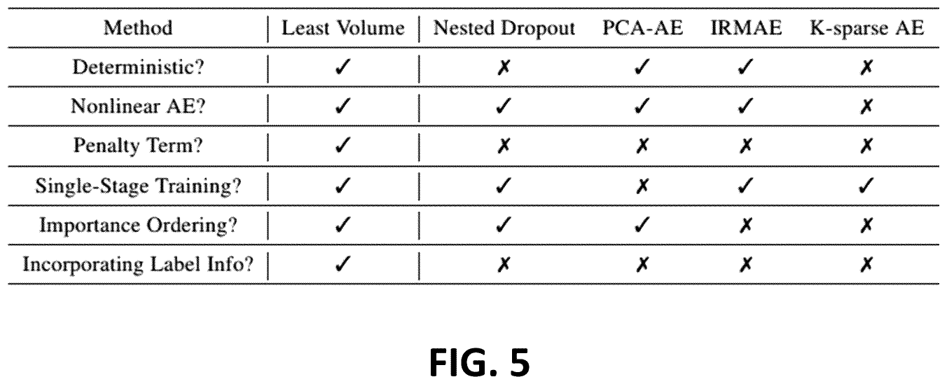

In some instances, it may be valuable to obtain information content that each latent dimension contains, and the latent dimensions may be ordered by their degrees of importance. A nested dropout may serve as a probabilistic way that makes the information content in each latent dimension decrease as the latent dimension index increases. PCA-AE may achieve a similar effect by gradually expanding the latent space while reducing the covariance loss. Certain example embodiments differ given that LV is deterministic, requiring no multistage training, and may only need the information content to decrease with the STD of the latent dimension instead of the latent dimension's index number. A detailed methodological comparison between the LV of certain example embodiments and some conventional methods is provided in the table of FIG. 5.

As described herein, the volume reduction may be employed to illustrate the characteristics of volume reduction, and employing LV may provide dimension reduction and ordering effect on toy problems and benchmark image datasets. For instance, according to certain example embodiments, LV may be applied to low-dimensional toy datasets to pedagogically illustrate its effect. The latent space dimension may be made equal to the data space dimension.

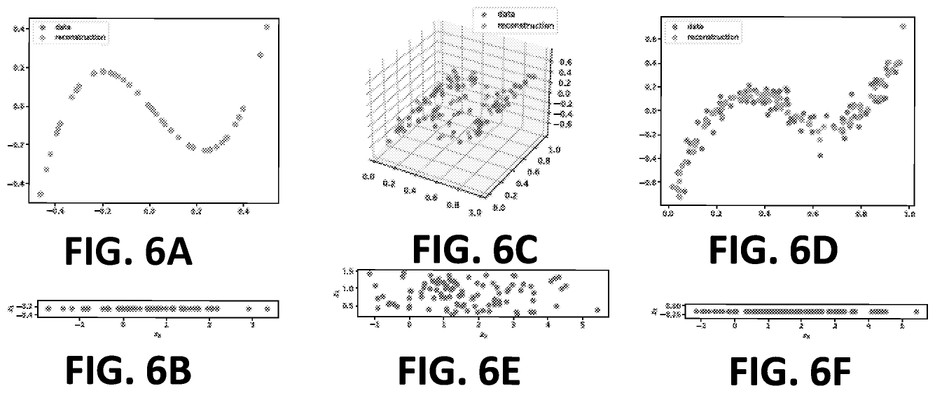

In certain example embodiments, the LV may be applied to low-dimensional toy datasets to pedagogically illustrate its effect. In each case, the latent dimension may be made equal to the data space dimension. FIGS. 6A-6F illustrate examples of the LV applied on low dimensional toy problems, according to certain example embodiments. In particular, FIGS. 6A-6F illustrate that the AEs regularized by LV successfully recover the low dimensionality of the 1D and 2D data manifold respectively in the latent spaces by compressing the latent sets into low dimensional latent subspaces, without sacrificing the reconstruction quality. With a large enough weight A for the volume penalty, in the noisy 2D problem, the AE may also manage to remove the data noise perpendicular to the 2D manifold (see FIG. 6D).

According to certain example embodiments, the performance of different latent regularizers that have the potential of producing a compressed latent subspace may be compared. Specifically, four regularizers may include: L₁ norm of the latent code (“lasso”); Lᵢ norm of the latent STD vector (“11”); volume penalty

$${L}_{vol}^{η}$$

with η=1 (denoted by “vol” or “vol_e1.0”); and a regularizer based on a t-distribution (denoted by “st”). The spectral normalization on the decoder may be activated and the four regularizers may be applied to a 5D synthetic image dataset of moving circles, the modified national institute of standards and technology (MNIST) dataset, the CelebA dataset, and the CIFAR-10 dataset. An investigation may then be performed to determine how good the regularizers are at reducing the latent set's dimensionality without sacrificing reconstruction performance, and to determine whether there is a high correlation between the latent STD and the degree of importance. For these image datasets, used latent spaces may be of 50, 128, and 2048 dimensions, respectively. For each case, the experiment may be performed over a series of λ (weights) ranging from 0.03 to 0.0001 with three cross-validation sand use the result's STD as the error bars.

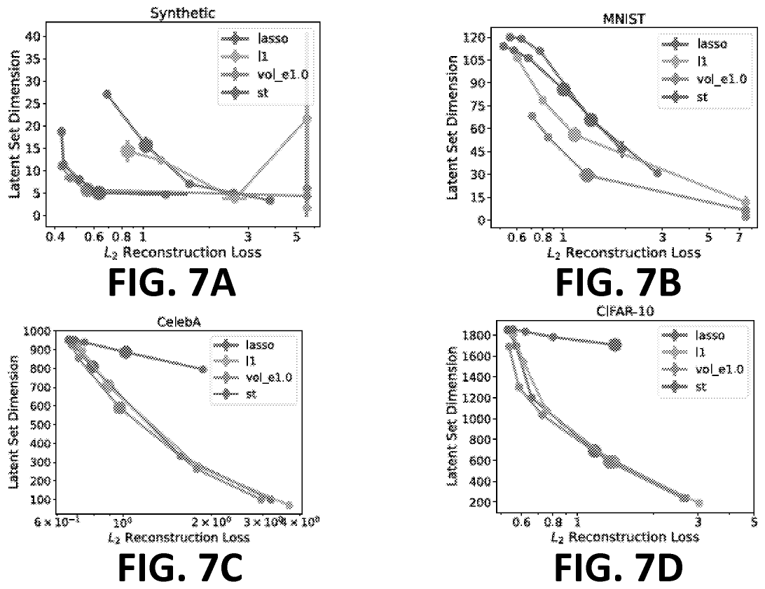

In comparing the regularizers' dimension reduction performance, each latent regularizer R, when paired with the reconstruction loss J via L=J+λ·R, creates its own loss landscape, such that the same λ leads to a different J for different R after optimizing L. This means that under the same λ, some regularizers may choose to compress the latent set by sacrificing their reconstruction quality more and, thus, these regularizers cannot be compared under the same λ. However, because adjusting λ is essentially trading off between reconstruction and dimension reduction, it may be possible to plot the dimension reduction metric against the reconstruction metric for comparison. An efficient R should compress the latent set more for the same reconstruction quality. FIGS. 7A-7D illustrate plots of the laten set dimension against the AE's L₂ reconstruction error, according to certain example embodiments. As illustrated in FIGS. 7A-7D, the latent set dimension is the number of dimensions left after cumulatively pruning the latent dimensions with the smallest STDs until their joint explained reconstruction exceeds 1%. It can be seen that for all datasets, the volume penalty

$${L}_{vol}^{η}$$

always achieves the highest compression when the L₂ reconstruction error is reasonable (empirically when the L₂ error is <2).

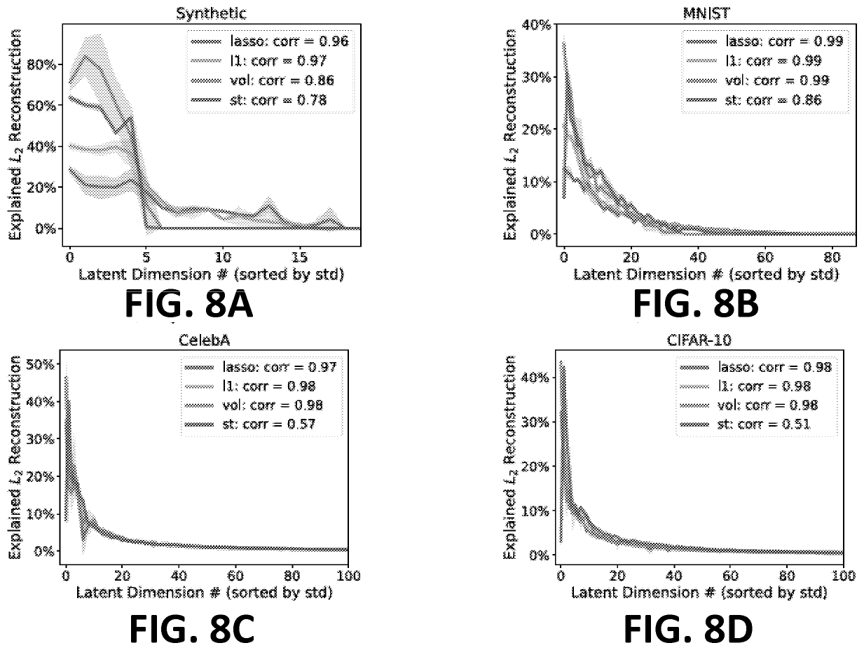

According to certain example embodiments, for each dataset, three autoencoding cases may be selected with comparable reconstruction quality respectively for the four regularizers. FIGS. 8A-8D illustrate examples of reconstruction vs latent dimension numbers, according to certain example embodiments. As illustrated in FIGS. 8A-8D, the latent dimensions may be sorted in descending order of STD value, and their individual explained reconstructions [symbol] _{D}(P) are plotted against their ordered indices. The L₂ distance may be selected as D (i.e., L₂(x̅p, x)=∥x̅p̅−̅x̅∥₂), and measure the Pearson correlation coefficient (PCC) between the latent STD and [symbol] _{L}_{₂} ({i}) to see if there is any similar ordering effect. If this coefficient is close to 1, then the latent STD can empirically serve as an indicator of the importance of each latent dimension similar to PCA.

For all regularizers, it may be seen that the L₂ reconstruction generally increases with the latent STD, although it is not perfectly monotonic. Nevertheless, it may be concluded that the reconstruction is highly correlated with latent STD since the PCCs are all close to 1 (except for “st” based on the student's t-distribution, which has a sudden drop as the dimension index reaches 0), as illustrated in FIGS. 8A-8D.

According to certain example embodiments, the DP algorithms' effectiveness may be demonstrated on several unlabeled datasets, and the results may be compared to the original LV AE without DP to show its improvement. In addition, the LV AE's generative process may be analyzed from the perspective of topology, and demythify several common misconceptions regarding AEs (e.g., disentangled representation). By leveraging the LVAE-DP's ability to retrieve the least dimensional latent space that can still topologically embed the dataset, different dataset's topological complexities may be evaluated with LVAE-DP.

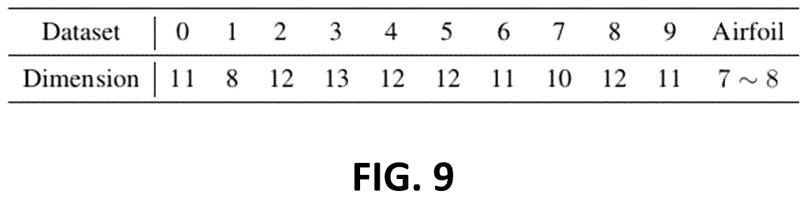

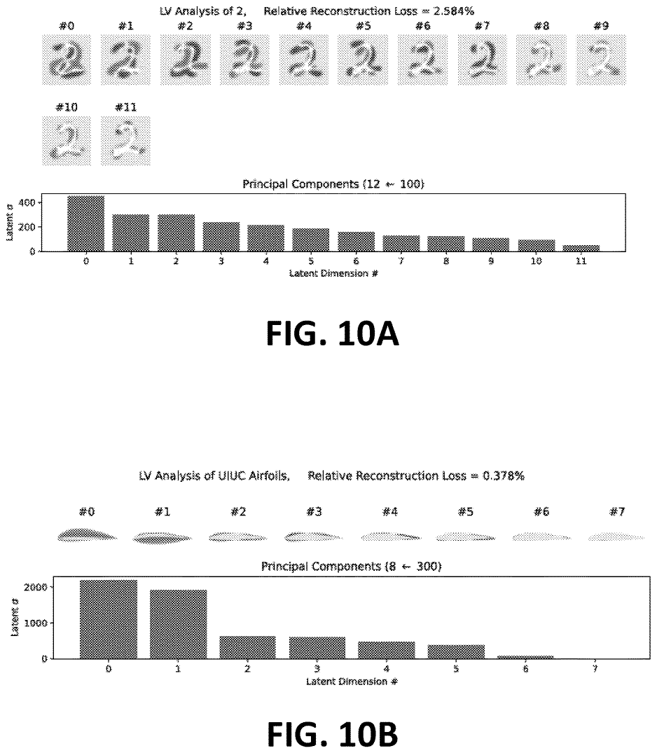

FIG. 9 illustrates an example table embedding dimensions of MNIST and University of Illinois Urbana-Champaign (UIUC) airfoils retrieved by LVAE-DP, according to certain example embodiments. Additionally, FIGS. 10A and 10B illustrate an example analysis of the UIUC airfoil dataset, according to certain example embodiments. As illustrated in FIGS. 10A and 10B, the relative reconstruction error is defined by ∥\hat{x}−x∥₁/( [symbol] ·dim X), where [symbol] is the length scale of pixel values (e.g., [symbol] =1 because the images are normalized) and dim X equals the number of pixels.

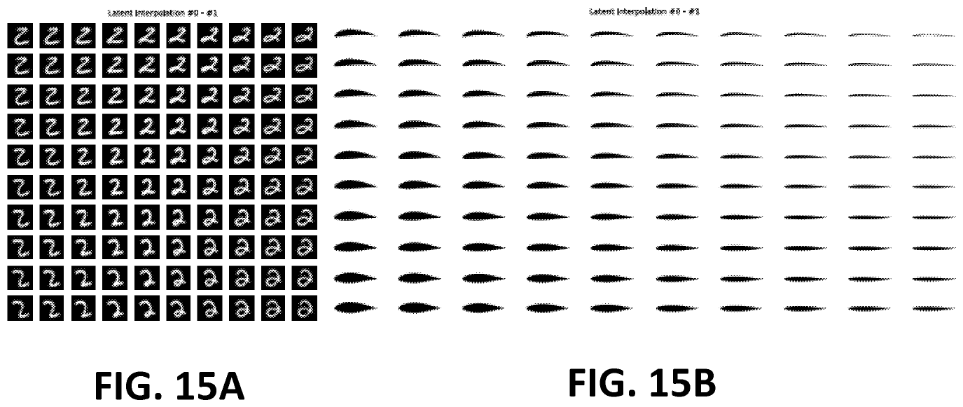

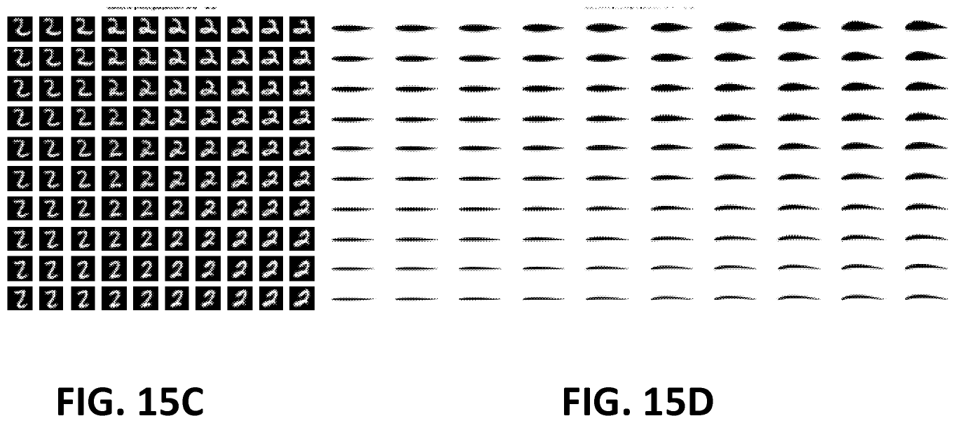

In certain example embodiments, the new LVAE-DP may be applied on a variety of datasets to demonstrate its power and effect. As illustrated in FIGS. 10A and 10B, results on the MNIST-2 dataset and the UIUC airfoil dataset are provided. It can be seen that the LVAE-DP not only significantly reduces the dimensions of the latent spaces, but also possesses a PCA-like effect on the latent space that makes the importance of the latent space scale with its STD. The data variations that these latent dimensions induce are illustrated in FIG. 15. Thus, the LVAE-DP may be regarded as a nonlinear generalization of the traditional linear PCA. The table of FIG. 9 summarizes the embedding dimensions retrieved by LVAE-DP.

According to certain example embodiments, the importance and necessity of the DP algorithm may be highlighted based on a few datasets of how the dimension reduction results of the new LVAE-DP and the old LVAE (based on

$${L}_{vol}^{′} )$$

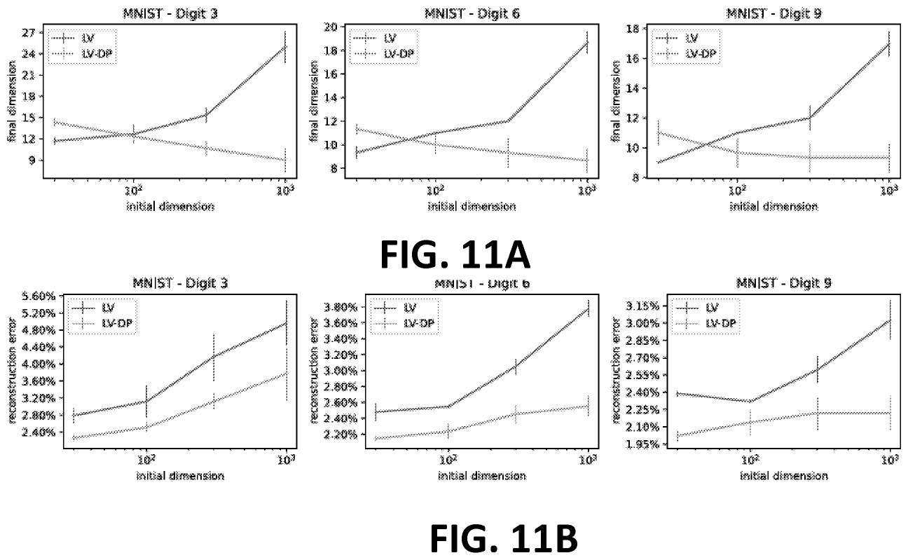

change with respect to different initial latent space dimensions dim Z. FIGS. 11A and 11B illustrate dimension reduction results of LVAE with and without DP, according to certain example embodiments. In particular, FIGS. 11A and 11B illustrate dimension results of LVAE with and without DP on MNIST datasets of digit 3, 6, and 9. All models shown in FIGS. 11A and 11B are trained for the same number of epochs, and the error bars indicate STD.

As illustrated in FIGS. 11A and 11B, the LVAE without DP tends to have worse dimension reduction performance as dim Z increases, given that not only its latent sets' final dimensions ∥ [symbol] ∥₀, but also its reconstruction errors increase with dim Z. In contrast, the LVAE with DP can consistently yield comparable ∥ [symbol] ∥₀ and reconstruction errors for different dim Z. Apart from that, the LVAE without DP also compresses the latent sets into latent subspaces of lower dimensions while achieving lower reconstruction loss. Thus, the DP algorithm can significantly improve the efficiency of LVAEs.

In certain example embodiments, retrieving the least dimensional latent space can alleviate the curse of dimensionality for downstream tasks, and may also improve the robustness of data sampling in the latent space. To show this effect, an ordinary AE without any regularization cannot serve as a good data generator, based on the experience that its decoder usually generates invalid data samples when it is fed latent codes randomly drawn from a simple latent distribution [symbol] _{z} (e.g., uniform or Gaussian distribution). Regularized AEs such as VAEs may be introduced to overcome this deficiency. However, such deficiency may not be blamed on the (ordinary) AE's simplistic formulation: If an AE (e. g)_{X↔Z} is trained to make [symbol] ∥g∘e(x)−x∥=0, then drawing the latent codes z only from the latent set [symbol] :=e( [symbol] )⊆Z must allow the production of realistic x=g(z) in the vicinity of the dataset [symbol] . Thus, the AE's g may become a valid data generator—as long as how to draw z is known from the latent [symbol] =e( [symbol] ) when there is no access to e and [symbol] .

In some instances, there may be mismatches between the intrinsic dimensionality of [symbol] and the latent space Z's dimension. For example, after training an AE (e, g) for a dataset [symbol] , g∘e(x)=x is obtained for all xϵ [symbol] , such that [symbol] ≃ [symbol] and e|ₓ is a topological embedding. Then, for any [symbol] ⁱ⊆ [symbol] with dim [symbol] ᵢ<dim Z, its latent set e( [symbol] )⊆ [symbol] must have measure zero in Z.

If the latent probability measure [symbol] _{z} is equivalent to the Lebesgue measure—i.e., they agree on which sets have measure zero (e.g., Gaussian measure) while supp P [symbol] ∩e( [symbol] ⁱ)≠φ, then [symbol] _{z} (supp [symbol] _{z}∩e( [symbol] ⁱ))=0, which means it is impossible to sample any subset of e( [symbol] ⁱ) via [symbol] _{z}. Thus, for [symbol] =∪ᵢ [symbol] ⁱ that satisfies dim [symbol] <dim Z, it is impossible to sample [symbol] using [symbol] _{z}, given that [symbol] _{z}( [symbol] )= [symbol] _{z}(∪ᵢe( [symbol] ⁱ))≤Σᵢ [symbol] _{z}(e( [symbol] ⁱ))=0. In consequence, z sampled from [symbol] _{z} falls outside [symbol] and, thus, are likely mapped to invalid x=g(z)∉ [symbol] , especially when the decoder g is injective over supp [symbol] _{z}.

To enable sampling z from [symbol] using such [symbol] _{z}, [symbol] _{z}(supp [symbol] _{z}∩ [symbol] >0. It can be achieved if supp [symbol] _{z}∩ [symbol] has non-empty interior, such that supp [symbol] _{z}∩ [symbol] has positive measure in Z. This becomes possible when dim Z=dim [symbol] . Specifically, if a manifold [symbol] ⁱ⊆ [symbol] satisfies dim [symbol] ⁱ=dim Z, then due to the invariance of domain, for any open set U⊆ [symbol] ⁱ\∂ [symbol] ⁱ, its homeomorphic latent set e(U)⊆ [symbol] must be open and, thus, of positive measure in Z because e|ₓ is injective and continuous. It follows that supp [symbol] _{z}∩e(U)≠φ⇒int(supp [symbol] _{z})∩e(U)≠φ⇒ [symbol] _{z}(supp [symbol] _{z}∩e(U))>0⇒ [symbol] _{z}(supp [symbol] _{z}∩ [symbol] ⁱ)>0. It becomes more ideal if [symbol] _{z}(supp [symbol] _{z}∩ [symbol] )>> [symbol] _{z}(supp [symbol] _{z}\ [symbol] ), which makes most z sampled from [symbol] _{z} fall inside [symbol] .

According to certain example embodiments, reducing the latent space Z's dimension to the dataset [symbol] 's embedding dimension can force the latent set [symbol] ≃ [symbol] to occupy a positive amount of space Z, such that (at least some part of) it becomes easier to sample.

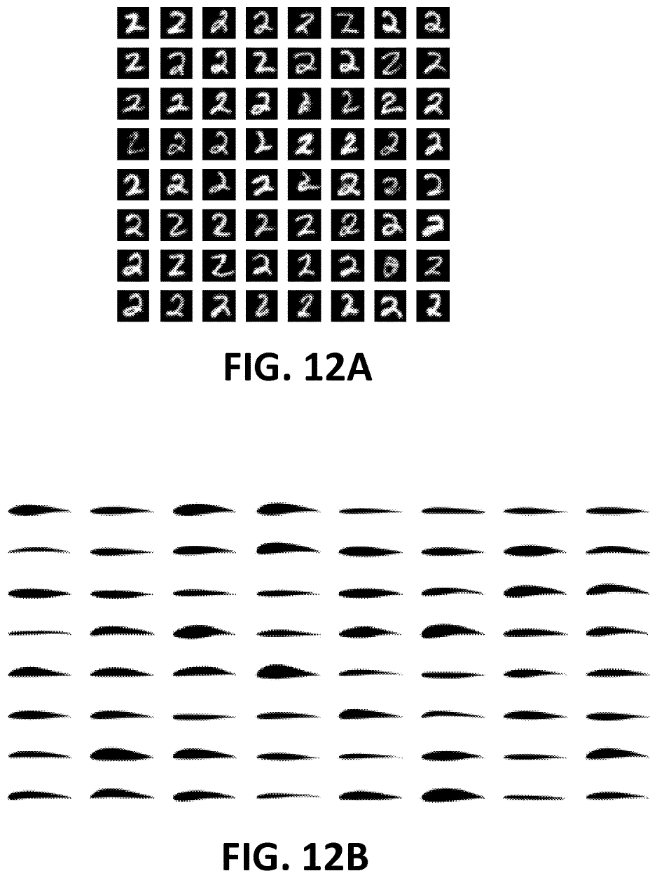

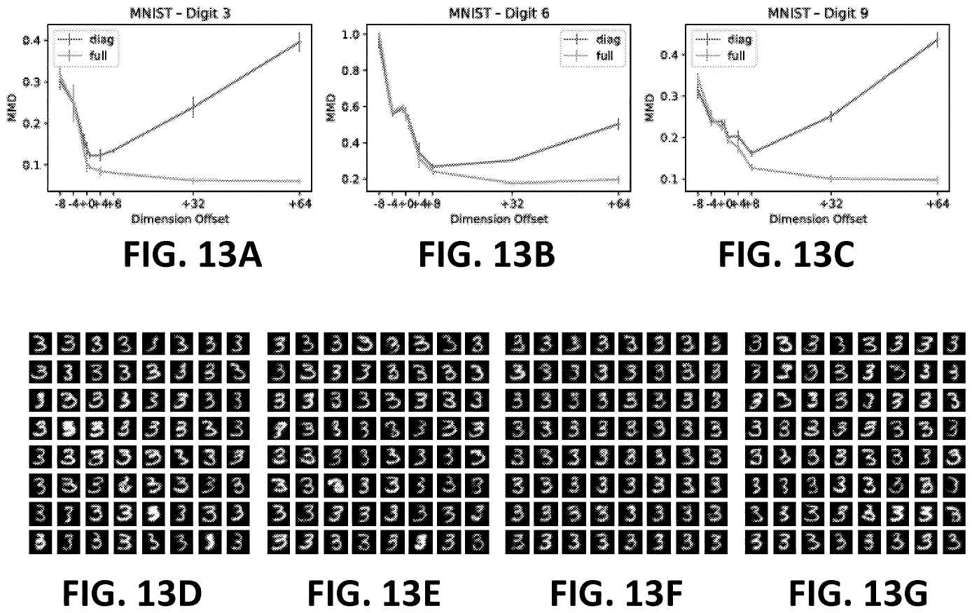

For verification, a series of ordinary AEs may be trained without any regularization on previous datasets. However, these AEs' latent dimensions may be set to the embedding dimensions shown in the table of FIG. 9 that were retrieved using LVAE-DP. After training, in each, a Gaussian approximation [symbol] _{z} of the distribution of e(x) was obtained (by evaluating e(x)'s mean and covariance), and sampling points z from this [symbol] _{z} to produce the latent Gaussian samples g(x)ϵX through decoder g. The samples in FIGS. 12A and 12B show that for regular AEs without regularization, when the latent space dimensions equal the dataset's embedding dimensions (or intrinsic dimension), g can become valid generative models when the Gaussian approximations are used as [symbol] _{z}. In particular, FIGS. 12A and 12B illustrate latent Gaussian samples produced by unregularized AEs with dim Z≈dim [symbol] . Additionally, FIGS. 13A-13G illustrate the relationship between latent Gaussian samples' quality and latent space dimension, according to certain example embodiments.

According to certain example embodiments, the sampling quality of g may change as the AEs' latent dimensions shift away from the estimated embedding dimensions with a certain offset. The maximum mean discrepancy (MMD) may be used to evaluate the discrepancy between distribution of the generated samples [symbol] _{g}:=g_{*} [symbol] _{z} and the data distribution [symbol] ᵣ. In each case, only a Gaussian approximation was used with diagonal covariance, and [symbol] _{g} deviates from [symbol] ᵣ when the latent space dimension moves away from the estimated dimension in either direction. However, if the Gaussian approximation has full covariance matrix, then the discrepancy between [symbol] _{g} and [symbol] ᵣ in general increases when the latent dimension decreases.

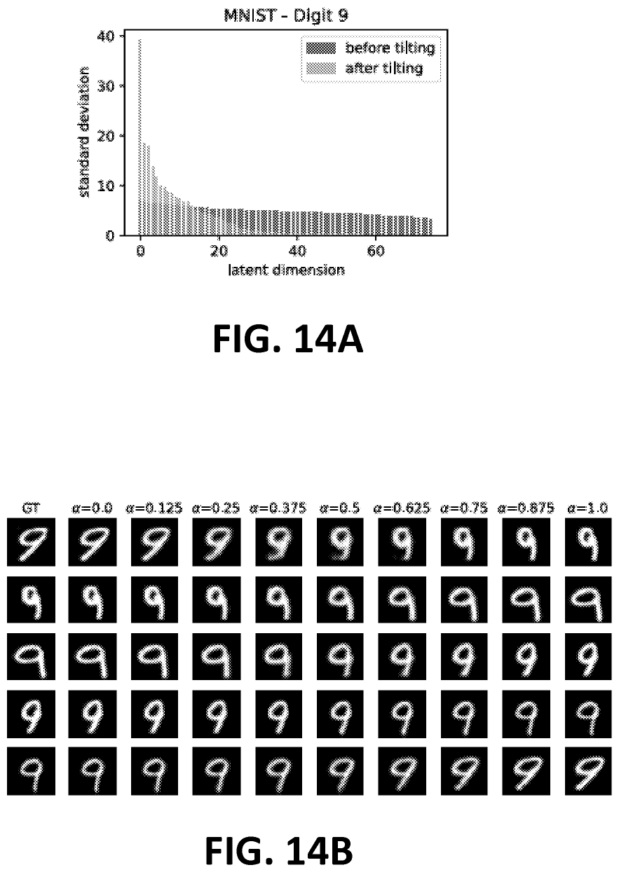

FIGS. 14A and 14B illustrate examples of an inspection of digit 9 latent set when dim Z=64>>dim [symbol] . If the latent set is tilted to align its principal dimensions with the latent space dimensions, and the STDs of all the latent dimensions are evaluated before and after the tilting, then the latent set may only have a few dimensions of large STD (see FIG. 14A). Additionally, when data samples in the latent space are interpolated, the interpolation yields realistic samples, which suggests the latent set is convex and, thus, cannot be curved (see FIG. 14B).

According to certain example embodiments, a regular AE without any regularization may also become a good data generator when the latent set can be sampled effectively. This may be achievable when the dataset is homeomorphic to a Euclidean ball. In one example, as long as the latent space dimension is not lower than the dataset's embedding dimension, the latent set may be homeomorphic to the dataset and may also be flattened in the latent space by the AE, even if the latent space dimension is higher than the embedding dimension.

FIGS. 15A-15D illustrate an example latent interpolation of LVAE-DP and unregularized AE in 2D latent subspaces, according to certain example embodiments. As illustrated in FIGS. 15A-15D, the unregularized AEs' latent dimensions are set to the embedding dimensions retrieved by LVAE-DPs. For the unregularized AEs, latent interpolation may be performed in the 2D linear subspaces spanned by the principal components of their latent sets, since unlike LVAE-DP, the unregularized AEs' latent sets do not have very diagonal covariance matrices (e.g., their latent dimensions are correlated).

According to certain example embodiments, there may be certain conditions for disentangled representations. The disentangled representation achieved by a decoder (or generator) g:Z→X with respect to a latent set C⊆Z and an image dataset [symbol] ϵX is a reflection of g|_{c}:C→X is continuous, g|_{c}:C→X is injective, and sup_{zϵC} in [symbol] dᵥ(g(z), x)<ϵ. In other words, g(C) is close to [symbol] everywhere.

Here, dᵥ is the perceptual distance human vision uses to visually differentiate between images, ϵ>0 is a threshold below which images are indistinguishable from each other with respect to dᵥ and C is a latent set (often convex) in which the latent interpolation is performed (e.g., the commonly used bounded cube in a 2D hyperplane spanned by two latent dimensions of Z.

The continuous injunctive function g: [symbol] → [symbol] may strictly be monotone. Specifically, due to the continuity of g, if any z is removed by a small amount, g(z) also changes by a small amount, so g(z) varies continuously as it is moved from any z₁ to any z₂ in the domain [symbol] . In addition, the injectivity of g implies that if z is moved from z₁ to z₂, the image g(z) may vary from g(z₁) to g(z₂) consistently (e.g., it changes without producing any duplicate g(z)=g(z₁) or g(z)=g(z₂) for all z between z₁ and z₂, such that g(z) appears to never stop varying as z moves from z₁ to z₂.

The continuity of g|_{c} prevents abrupt change in g(z) as z is linearly interpolated between any z₁∈C and z₂∈C. The absence of continuity leads to shattered and fragmented representations. Thus, in certain example embodiments, g|_{c} may be needed to be bi-Lipschitz with respect to the L₂ distance in C and the perceptual distance dᵥ in X for a more uniform change of g(z) across C.

The injectivity of g|_{c} may be an important condition. It not only means g(z) changes consistently if any z∈C is moved along a single latent dimension i—i.e., g(z+α·eᵢ=g(z+β·eᵢ)⇔α=β, where eᵢ is the standard basis vector, but also implies that g(z) must change differently if z is to be moved along a different latent dimension j—i.e., g(z+α·eᵢ)=(g(z+β·eᵢ)⇔α=β=0. Thus, there comes the modularity and compactness that each latent dimension controls a single factor of data variation distinctively.

Another perceptual metric condition may ensure that every z∈C is mapped to a realistic image in the vicinity of the dataset [symbol] , so that the latent interpolation on C generates valid samples. The low dimensionality of latent space may be helpful for finding C satisfying this condition.

According to certain example embodiments, the AEs may be trained in ways that enforce the above-described conditions. For instance, the AEs may have continuous decoders g by construction, and the reconstruction loss [symbol] ∥x−g∘e(x)∥ forces g to be injective over [symbol] =e( [symbol] ) and satisfy g( [symbol] )= [symbol] . Moreover, setting the latent dimension to the intrinsic dimension of [symbol] gives [symbol] non-empty interior int( [symbol] )⊆Z, so when the latent interpolation is performed within a 2-D latent linear subspace [symbol] ′⊆Z that has intersection with int( [symbol] ), the intersection int( [symbol] )∩Z′ is open in Z′. Due to this openness, every z∈int( [symbol] ))∩Z′ can have open balls as its neighborhoods—which are convex—so that some convex C⊆int( [symbol] )∩Z′⊆Z′ as the latent subset for interpolation may be found. In consequence, g|_{c} is a continuous injection, and g(C)⊆g( [symbol] )= [symbol] . It may be ideal if [symbol] (or a great part of it) is convex, given that a large C can then be found to produce g(z) of large variation.

In certain example embodiments, VAE and its variations, such as β-VAE and FactorVAE have loss functions that include a reconstruction loss and a regularization loss. Unlike deterministic AEs, their encoders may be modelled by a parametric Gaussian conditional distribution q(z|x)= [symbol] (z|μ(x), diag(σ²(x))). However, their reconstruction loss similarly encourages x=g∘μ(x) for x∈ [symbol] , which, if achieved, makes the continuous g injective over [symbol] =( [symbol] ). Moreover, their regularizers may include the penalty:

$${𝔼}_{x} {D}_{KL} ( q ( z \vert x ) \vert p ( z ) ) = ( \frac{1}{2} ) {Σ}_{i} {𝔼}_{x} {μ}_{i}^{2} ( x ) + ( \frac{1}{2} ) {Σ}_{i} {𝔼}_{x} ( {σ}_{i}^{2} ( x ) - log ( {σ}_{i}^{2} ( x ) ) - 1 ) ,$$

where the first term

$$\frac{1}{2} {Σ}_{i} {𝔼}_{x} {μ}_{i}^{2} ( x )$$

makes μ(x) sparse over [symbol] , and the second term encourages σᵢ(x) to coverage to 1 if possible. This may induce a similar compression effect that makes [symbol] =μ( [symbol] ) lie in a low dimensional subspace in Z. In the results, the VAEs may learn many uninformative latent dimensions with μᵢ(x)≈0 and σᵢ(x)≈1. Thus, if this compression is effective enough to reduce that latent subspace's dimension to [symbol] 's intrinsic dimension, it may induce a similar disentanglement effect when some 2-D subspaces are interpolated in it.

InfoGAN is a generative adversarial Network (GAN) with mutual information maximization (MIM). GANs—typically with continuous generators g—may be trained to make g_{*}( [symbol] _{z})= [symbol] ᵣ, where g_{*} is the pushforward operator of g and [symbol] _{z} is a specified latent probability measure. [symbol] _{z} may be set to a Gaussian or a uniform distribution, whose support supp [symbol] _{z} is a convex set with non-empty interior in Z. If Z′ is selected intersecting int(supp [symbol] _{z}) and C⊆int(supp [symbol] _{z})∩Z′ is selected, then a GAN's training process makes g(C)⊆ [symbol] ⊆supp [symbol] ᵣ. Furthermore, the MIM of InfoGAN enforces [symbol] _{z~C}∥z−e∘g(z)∥=0, where e is a continuous encoder modeling the auxiliary Gaussian distribution. This makes z=e∘g (z) for all z∈C, thus g|_{c} is injective. In contrast, the GANs without MIM do not have the disentanglement effect, as its g|_{c} is not necessarily injective and, thus, g(C) can have self-intersections.

In certain example embodiments, low dimensionality may be important for efficiency and robustness. Continuity may be important if the inputs or outputs of the downstream tasks must be continuous with respect to [symbol] . The importance of injectivity, which may serve as the cornerstone of disentanglement, may be un clear. Injectivity may simplify optimization tasks in which the z=g⁻¹(x) for a desired x∈ [symbol] need to be found, since z is then unique. It may also improve analysis and interpretation of the datasets. Nevertheless, injectivity may be more like a pleasing byproduct of seeking low dimensional representations using AEs, as it may be necessary to make the latent sets homeomorphic to the datasets to avoid trivial solutions.

Certain example embodiments may investigate LVAE-DPs efficacy on some datasets of larger scales and potentially of much more complicated topological structures. This may include, for example, the whole MNIST) dataset and the CelebA dataset.

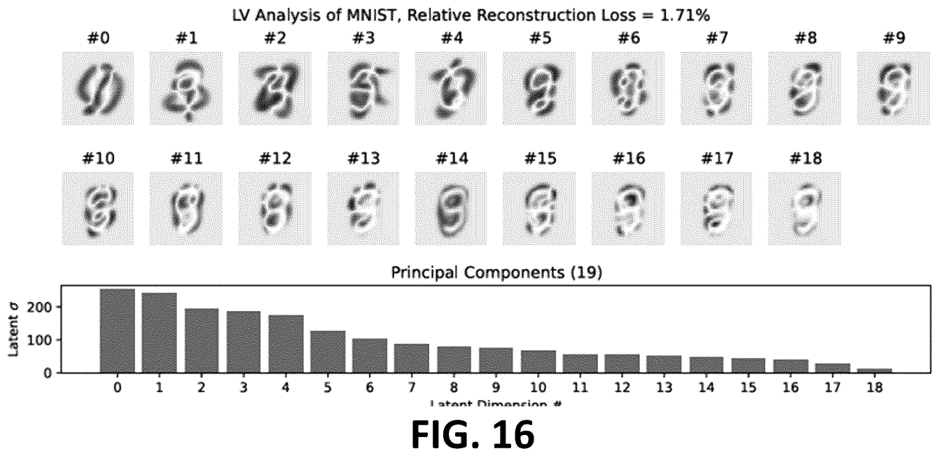

In certain example embodiments, the MNIST may include a union of 10 balls of different dimensions, and the embedding dimension fo the entire dataset is no less than the largest dimension of the balls—13 (for digit 13). If these 10 balls are disjoint, the entire MNIST's embedding dimension may agree with this dimension. However, LVAE-DP shows that the embedding dimension of MNIST is about 19 (as illustrated in FIG. 16), which is much larger than 13.

The results of the LV analysis of MNIST illustrated in FIG. 16 shows that some digit sets may have intersections with each other at some point. The UMAP result shows that the digit sets of 4 and 9 may be connected, which is likely given that 4 and 9 are homotopy-equivalent. The digit sets of 3, 5, and 8 also appear connected for similar reasons. Thus, the entire MNIST dataset may not e locally Euclidean at some of the intersections, which may be why the MNIST dataset cannot be embedded in a 13-D latent space.

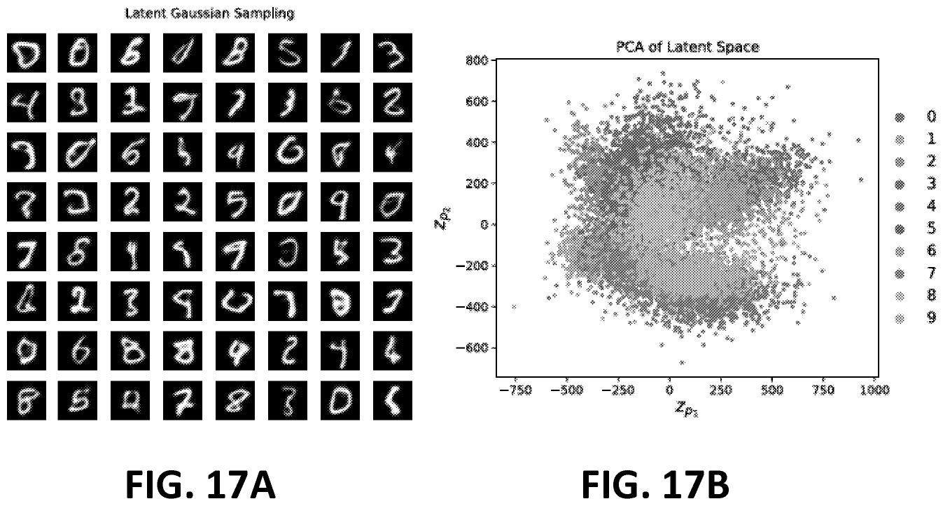

Another interpretation of the MNIST dataset is that the MNIST's latent set in the 19-D latent space may be harder to sample using a single latent Gaussian approximation since it is homeomorphic to the MNIST dataset and, thus, also consists of 10 balls that may intersect each other. FIG. 17A illustrates latent Gaussian samples of the LVAE-DP trained on the entire MNIST dataset, according to certain example embodiments, and FIG. 17(B illustrates the latent code's distribution (projected into the 2-D principal subspace) of the LVAE-DP trained on the entire MNIST dataset, according to certain example embodiments. As illustrated in FIG. 17A, many digits produced by the latent Gaussian approximation [symbol] _{z} are invalid or distorted, which means [symbol] _{z}(supp [symbol] _{z}∩ [symbol] << [symbol] _{z}(supp [symbol] _{z}\ [symbol] ) (i.e., [symbol] constitutes a small portion of the Gaussian ball supp [symbol] _{z}. The plot of the MNIST dataset's latent code in FIG. 17B also shows that a single Gaussian should not be an accurate approximation of the entire MNIST's latent code distribution.

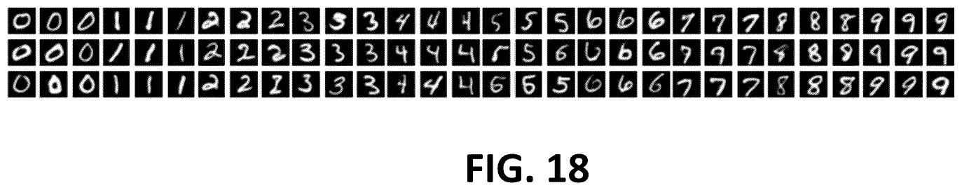

Since the latent space dimension is larger than all digit sets' embedding (or intrinsic) dimensions, each digit's latent set is not necessarily flattened in the latent space, provided that the AE's flattening effect does not exist. Thus, if each digit's latent set is curved, its distribution may not be well approximated by a Gaussian. FIG. 18 illustrates an example of individual latent Gaussian samples of the 10 digits, according to certain example embodiments. As illustrated in FIG. 18, it can be seen that each individual latent Gaussian sampling produces some distorted and invalid digits. Thus, some latent codes sampled from the latent Gaussian approximations may fall outside [symbol] .

Based on the above findings, by construction, AEs may not be ideal to serve as generative models for datasets whose embedding dimensions are larger than their intrinsic dimensions. As such, purely-AE-based generative models perform poorly on a large scale, high dimensional datasets, as many of them may be unions of intersecting manifolds of various intrinsic dimensions.

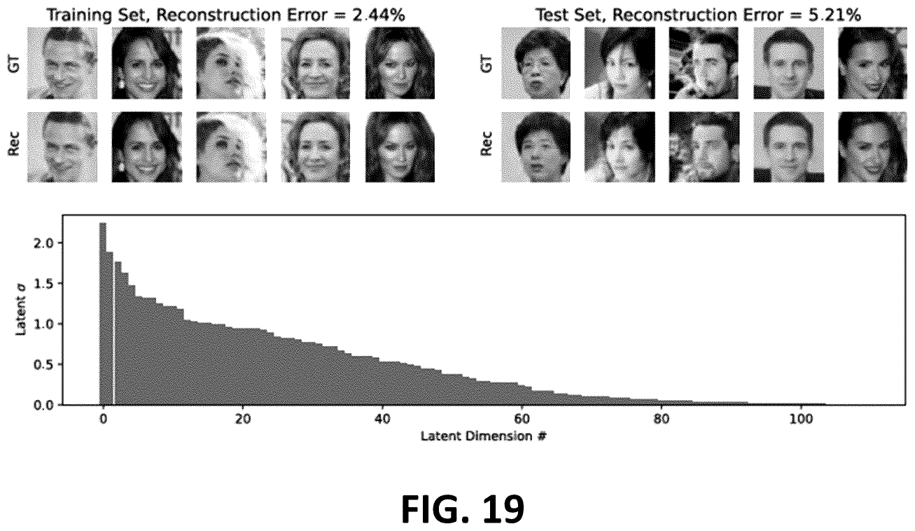

In some example embodiments, it may be possible to inspect LVAE-DP's results on the CelebA dataset, which is more complicated than MNIST. FIG. 19 illustrates LVDP-AE's reconstruction of CelebA images and the distribution of 110 latent σ, according to certain example embodiments. In particular, FIG. 19 shows that LVAE-DP achieves great dimension reduction performance on the CelebA dataset, reducing the AE's latent dimension from 4000 to 110, which may be an accurate estimate of the embedding dimension or the intrinsic dimension of 64×64 human face images. Its reconstruction error on both the training set and test set are also low enough to make the facial patterns well reconstructed, and there is no blurriness that is typically seen in the VAE's results.

Certain phenomena may be observed with regard to the latent set's topological structure. For instance, FIGS. 20A and 20B illustrate samplings in the CelebA LVAE-DP's latent space, according to certain example embodiments. In particular, FIG. 20A illustrates latent Gaussian sampling with Σ/10, and FIG. 20B illustrates latent Gaussian sampling with full Σ. In FIGS. 20A and 20B, latent Gaussian sampling produces many images with either distorted backgrounds or distorted faces, which may suggest that the latent set may not have a simple topological structure upon which these latent codes easily fall. However, if the latent Gaussian approximation's covariance matrix is shrunk by 10, it may be possible for only sample latent codes to be in the vicinity of the latent set's mean (or center), and the decoder may produce images with realist faces but grayish and blurry backgrounds. These stand in contrast to the much sharper reconstructions of true images in the dataset, suggesting that the decoder may have the ability to produce sharp images, but the sharper images' latent codes may be uneasy to sample using a Gaussian distribution.

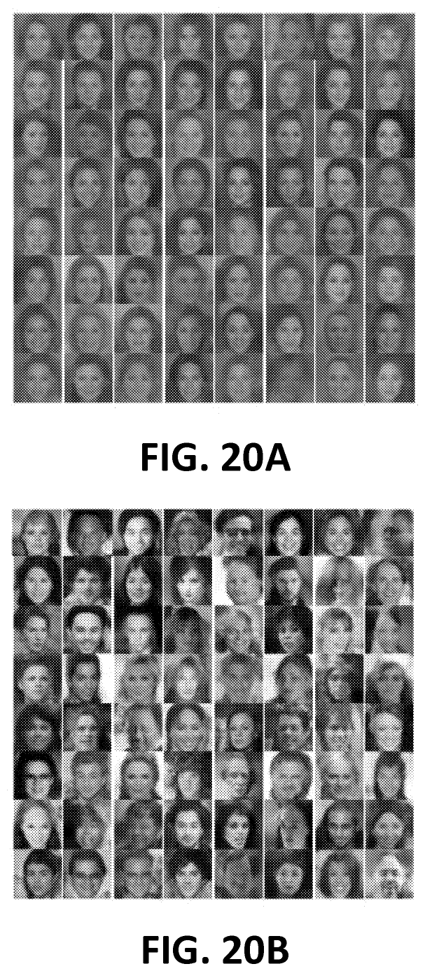

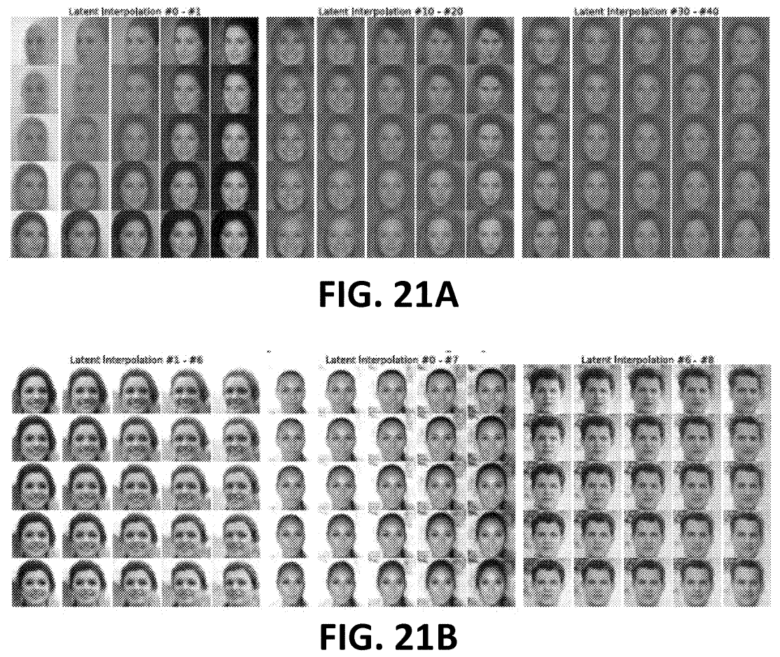

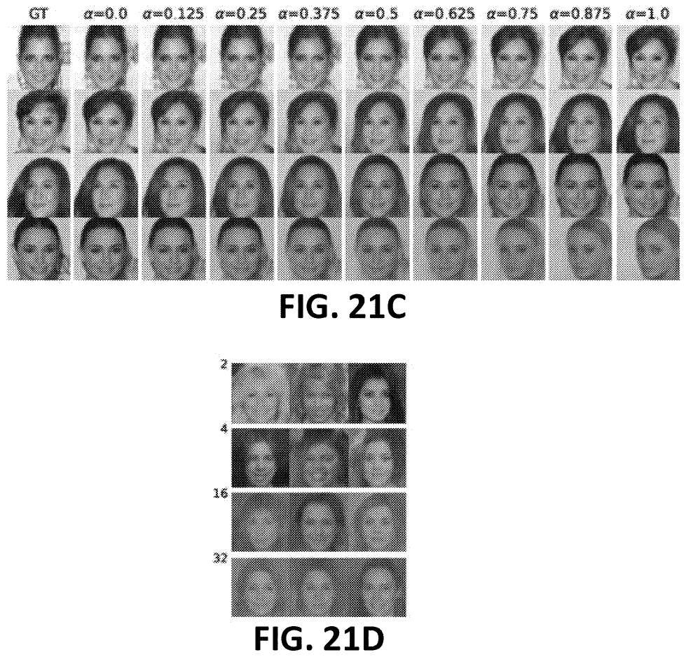

FIGS. 21A-21D illustrate example interpolations in the CelebA LVAE-DP's latent space, according to certain example embodiments. FIG. 21A illustrates latent interpolations around “smiling lady”—the center of Z, and FIG. 21B illustrates latent interpolations around different data samples. From FIGS. 21A and 21B, the latent interpolation at the latent set's mean produces face variations in a variety of factors, from primary factors such as age, gender, pose and race, to minor factors such as jaw opening, eye expression and mood. The interpolation also works properly when the interpolation is performed at different images from the dataset. This suggests that the latent set may have a non-empty interior in the final latent space, and each data point may have an open neighborhood in the latent space.

FIG. 21C illustrates latent interpolations between data sample pairs, according to certain example embodiments, and FIG. 21D illustrates multicombinations, according to certain example embodiments. From FIGS. 21C and 21D, the linear latent interpolation between an arbitrary pair of images usually leads to valid and smooth face transitions, despite situations where sometimes the interpolation may yield distorted human faces along the way. However, as the number of data samples increase to be convexly combined in the latent space (e.g., from 2 to 4 to 16 to 32, as shown in FIG. 21D), their convex combination becomes closer to the latent set's center and looks more grayish back in the data space. Additionally, although the latent convex combination of a few samples may produce invalid images with distorted faces, this may become less frequent as the number of samples to be combined increases.

A possible explanation of the findings related to FIGS. 21A-21D may be that the CelebA dataset—or, more generally, the set of all human face images—is a high dimensional oval ball with a rough and spiky surface, in which most of the colorful and sharp face images are located near the surface, whereas the desaturated and blurry images are around the center of the ball. This hypothesis may provide an explanation of the phenomena as follows.

In high dimensional spaces, the Gaussian distributions may be similar to soap bubbles, with most of their mass concentrated around the surfaces of their supports. This means that if the latent Gaussian sampling is performed without any adjustment, it may almost always be sampling latent points near the support ball's spherical surface, and it may only be possible to effectively sample the interior of the ball by scaling down the covariance matrix. Thus, if the latent set [symbol] is a ball with a rugged and spiky surface, then the Gaussian distribution's surface-sampling may sometimes produce invalid samples falling between the “valleys” and “canyons” on the surface and, thus, outside the latent set, as shown in FIG. 20B. In contrast, sampling the interior leads to valid samples inside the ball, as shown in FIG. 20A. In particular, FIG. 20A illustrates latent Gaussian sampling with Σ/10, according to certain example embodiments, and FIG. 20B illustrates latent Gaussian sampling with full Σ, according to certain example embodiments. FIGS. 20A and 20B illustrate examples of samplings in the CelebA LVAE-DP's latent space, according to certain example embodiments.

A spiky rugged ball is still topologically a ball and, thus, the latent set Z has a non-empty interior that can intersect a given 2-D latent plane and produce a latent intersection C with non-empty interior on this plane such that all the points inside C can yield valid images and leads to the disentanglement effect.

If two points were randomly selected on the surface of the rugged “planet” [symbol] and connect them using a straight line, then this line may intersect Z and yield valid samples when 1) the points are far away from each other (e.g., in different hemispheres), or 2) the points are close to each other but both are at the “sea level”, so the “crust” of [symbol] can still block (i.e., intersect—the straight line). On the other hand, the line circumvents [symbol] and produces invalid human faces when at least one data point is on a tall spiky “mountain” such that no part of [symbol] blocks the straight line.

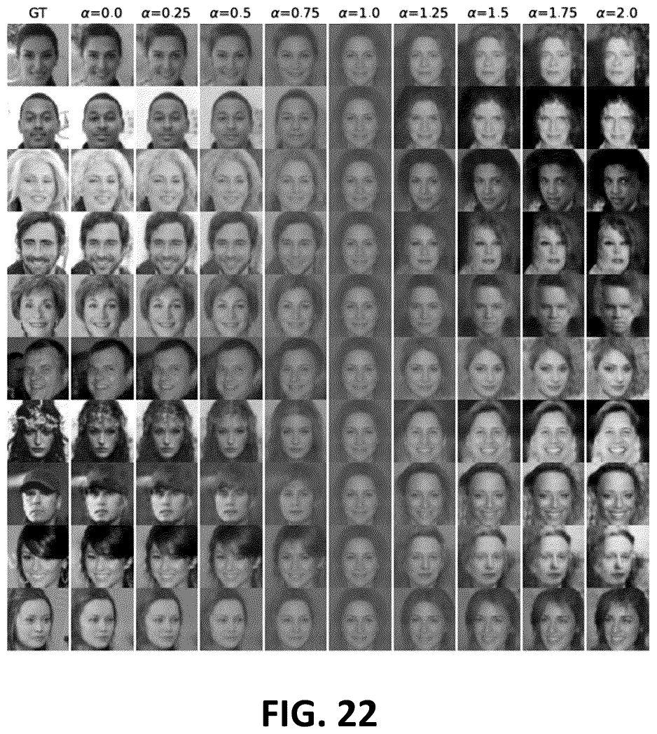

To further verify this hypothesis, the latent antipodes test may be performed. In this test, the starting point may be from several data samples' latent codes z₀ and drill holes along the potential planet [symbol] 's diameter all the way to its core—the mean μ( [symbol] ), then continue drilling for the same distance until one comes out of the other side of [symbol] , and inspect what was acquired along the way. In other words, one can linearly interpolate in the latent space along the line z(a)=(1−a)z₀+αμ( [symbol] ) from α=0 to α=2, and feed z(a) to the decoder g to produce images. The result in FIG. 22 verifies that the other side of “planet” [symbol] is still a valid human face image.

According to certain example embodiments, GLV may be tested on two datasets of different types of labels—the MNIST dataset with a discrete label set of digit categories, and the UIUC dataset with a connected label set of lift and drag coefficients. As to MNIST dataset, the architecture of the AE for MNIST is not very different from the unlabeled dataset except for two modifications. First, an additional 1-Lipschitz label predictor

$${g}_{θ}^{y} : Z \to Y$$

may be introduced, where 10 labels are one-hot encoded to make their mutual distances equal to 1. When training the GLV AE, this predictor may be connected to softmax activation, and the predictor may be trained with cross entropy. Second, the Lipschitz constant of the image decoder

$${g}_{θ}^{x} : Z \to X$$

may be increased to 1024 to scale down the latent set's length scale to around 1 (in contrast to the large length scale in FIG. 17B caused by the 1-Lipschitz

$${g}_{θ}^{y} ) ,$$

so that the label predictor

$${g}_{θ}^{y}$$

and the one-hot labels can adjust the distances between the latent codes.

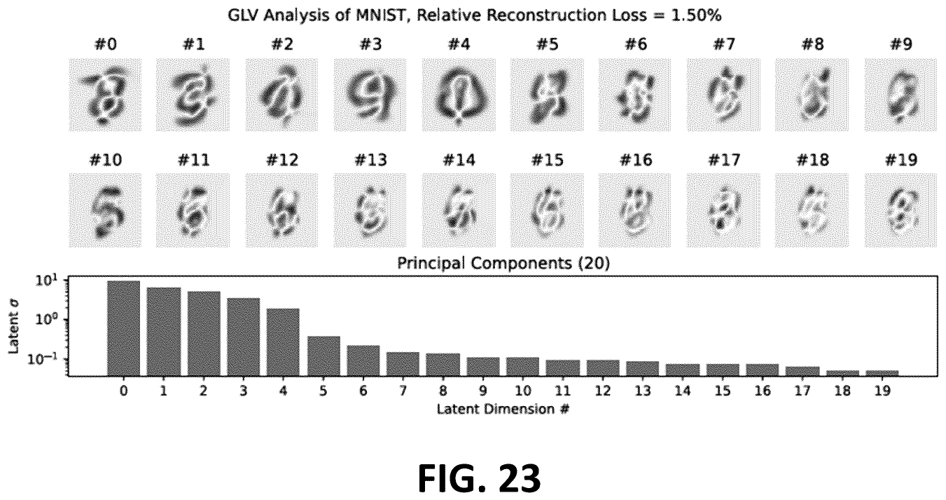

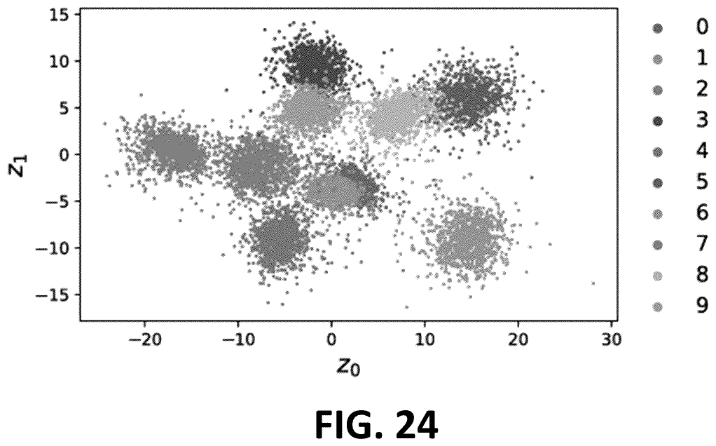

FIG. 23 illustrates an example of latent dimensions of the GLV AE of MNIST, according to certain example embodiments. In particular, FIG. 20 shows the 20 principal components extracted by GLV, which is one more than the 19 components extracted by LV, as previously described. In contrast to FIG. 16, there are 5 major latent dimensions whose length scales are about one order of magnitude larger than the rest, which is possibly induced by the additional label information. If the latent codes are projected into the 2-D subspace spanned by dimension #0 and #1 then plot them out in FIG. 24, it can be seen that a distinctive clustering pattern is absent from FIG. 17B. In particular, FIG. 24 illustrates an example distribution of MNIST digits in the GLV latent space, according to certain example embodiments. The images from different classes converge into distinct clusters that look well-separated from one another.

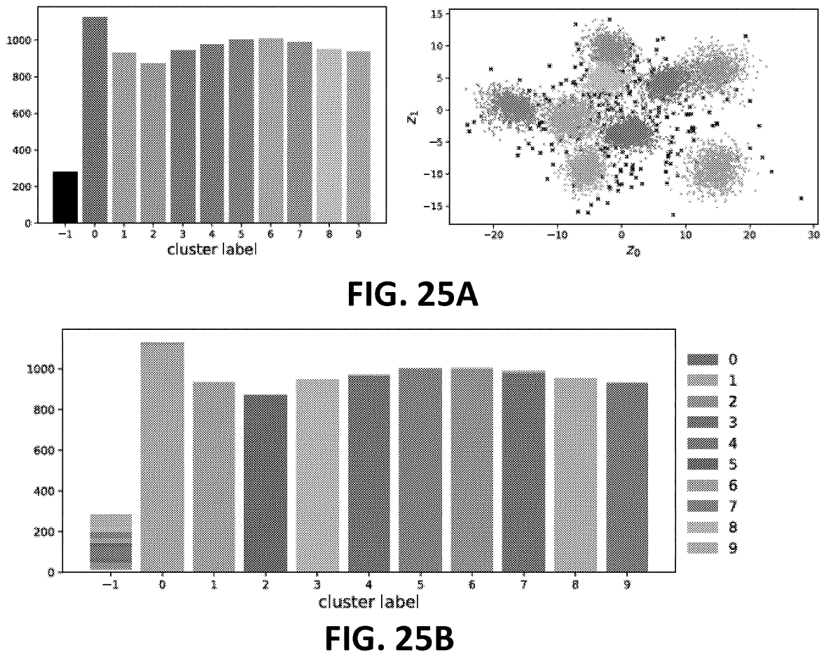

To see if the clusters are truly well-separated (given that some clusters overlap in the 2-D space), hierarchical density-based spatial clustering of applications with noise (HDBSCAN) may be applied on the latent set. The parameters of HDBSCAN may be set as m_{clsize} to mₚₜₛ to 5. Its result is illustrated in FIGS. 25A and 25B. In particular, FIG. 25A illustrates an example distribution of HDBSCAN clusters, according to certain example embodiments, and FIG. 25B illustrates contents of HDBSCAN clusters. As illustrated in FIGS. 25A and 25B, this density-based clustering algorithm may determine the clusters apart sufficiently, as each cluster (except the noise cluster #1) consists almost exclusively of a single MNIST digit (as shown in the stacked bar chart of FIG. 25B. In comparison, HDBSCAN classifies approximately 70% latent points in FIG. 17B as noise, showing no similar clustering effect in LV's representation. Thus, GLV, when applied on a dataset with categorical labels, has an effect of resembling contrastive learning that makes the MNIST images of different labels stay apart from each other, while images of the same class cluster are closely together in the latent space.

According to certain example embodiments, the categorical label may correspond to the input data that has a given discrete label tied to it (e.g., an image with the label “cat”). The specific categories of the labels may be, but not limited to, for example, a real number, an integer, a text string, etc. According to some example embodiments, when a label has a finite number of possible values, the label may be regarded as a categorical label. For instance, when the total number of types of animals is finite, animal names may be a type of categorical label. On the other hand, a lift coefficient of an airfoil may be any real number between 0 and 2 and, thus, there is a finite number of values that the lift coefficient can take. Thus, the lift coefficient would not classify as a categorical label.

In certain example embodiments, the data re not always samples in a dataset paired with labels. Instead, it may be possible to inspect how GLV operates when only a few labelled samples are given while the rest of the dataset remains unlabeled. To this end, the same experiment in FIGS. 25A and 25B may be performed three times but using different amounts of labelled data samples—50%, 10%, and 2% of the training set—to train the predictor

$${g}_{θ}^{y} .$$

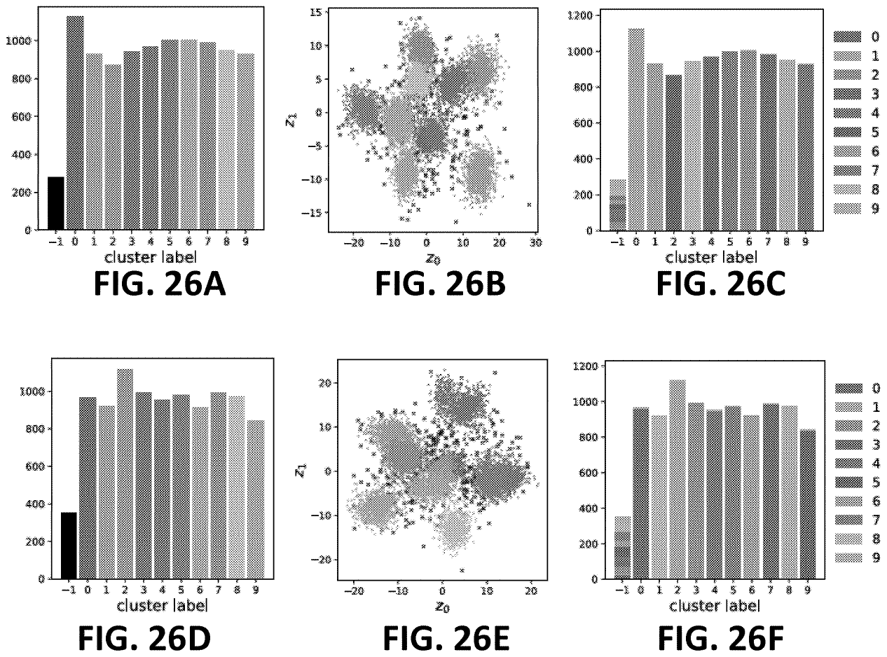

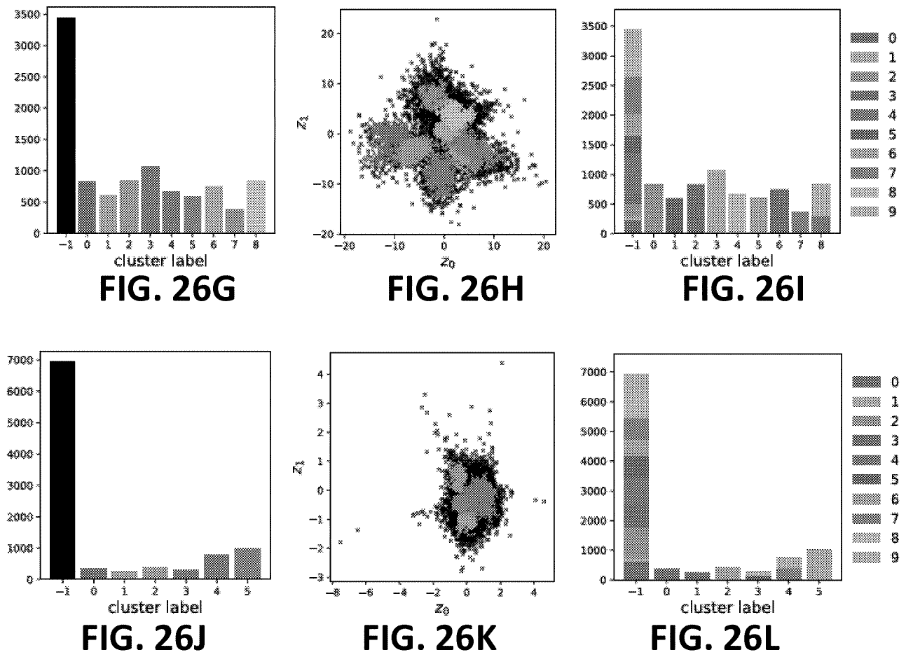

The results of the experiment from FIGS. 25(a) and 25(b) are shown in FIGS. 26A-26L. In particular, FIGS. 26A-26L illustrate HDBSCAN results on MNIST's GLV representation with different amounts of labels, according to certain example embodiments. It can be seen from FIGS. 26A-26L that as the amount of labelled samples for training the GLV AE is decreased, HDBSCAN beings to regard more latent codes as noise, and more often allocate different digits into the same clusters, and these clusters may get closer to each other. This result occurs when the latent codes fail to conglomerate to form clusters effectively. However, when the amount of labelled samples is 50%, the result is comparable to the 100% case illustrated in FIGS. 25A and 25B. Thus, to make GLV induce the clustering effect on a labelled dataset, all the data samples do not necessarily need to be labelled, but the amount of labeled samples must be sufficient.

According to certain example embodiments, supervised LV may also be applicable in UIUC airfoils with lift and drag coefficients. For example, in airfoil optimization, the airfoil's lift coefficient C_{L} and drag coefficient C_{D} may be important coefficients for consideration under different environmental conditions. To determine which parts of the airfoil shape contribute the most to these two coefficients, the UIUC airfoil dataset may be passed to a CFD simulator to generate a labeled airfoil dataset for GLV analysis. The dataset may be created by first taking the artesian product between the airfoil shapes and a variety of Mach numbers (Ma), Reynolds number (Re) and Angle of Attack (AoA), then passing the samples from this product to a CFD simulator to derive the corresponding lift and drag coefficient.

All airfoil simulations may be run using the MACH-Aero framework. In the framework, structure volume meshes may be extruded using pyHyp, a hyperbolic mesh generator, which were then used to run Reynolds Averaged Navier Stokes (RANs) simulations in the open source Adflow solver. All simulation may use the Spalart-Allmaras model to capture turbulent effects. Additionally, the solver may use the Newton-Krylov (ANK) method for improved convergence properties. The resulting dataset may have 46,900 samples of the triplet form (x, c, y), in which x denotes airfoil shape, c denotes boundary conditions (e.g., Ma, Re, and AoA), and y denotes performance (C_{L} and C_{D}). Here, Ma may range from 0.4 to 0.9, Re may range from 1e6 to 2e7, and AoA may range from 0° to 20°.

The airfoil's GLV problem may have a variation in the architecture of

$${g}_{θ}^{y} .$$

In this application,

$${g}_{θ}^{y}$$

may serve as a surrogate for predicting C_{L} and C_{D} given x and c, so it has the form

$${g}_{θ}^{y} ( z , c )$$

instead of

$${g}_{θ}^{y} ( z ) ,$$

taking the boundary condition c as an additional input. Despite that, if it is assumed that the performance mapping X×C→Y is continuous, then

$${g}_{θ}^{y} : Z \times C \to Y$$

can be viewed equivalently as

$${g}_{θ}^{y}$$

(c):Z→Y. Thus, the constraints may be generalized by requiring them to hold under all c. With this generalization, the reconstruction loss can be reformulated as

$${{𝔼}_{x , c , y} ‖ {g}_{θ}^{χ} ( {e}_{θ} ( x ) ) , {g}_{θ}^{y} ( {e}_{θ} ( x ) , c ) ) - ( x , y ) ‖}_{2} ,$$

and the second part of the constraint becomes

$${max}_{c} {‖ {g}_{θ}^{y} ( {z}_{1} , c ) - {g}_{θ}^{y} ( {z}_{2} , c ) ‖}_{2} \leq K {‖ {z}_{1} - {z}_{2} ‖}_{2} .$$

In other words,

$${g}_{θ}^{y} ( z , c )$$

should be K-Lipschitz with respect to z at every c. Intuitively, enforcing this constraint in GLF may push two airfoils x₁ and x₂ far away from each other if there exists any condition c under which they have very different coefficients y₁ and y₂, making the performance y never change abruptly as z varies. To make

$${g}_{θ}^{y}$$

only K-Lipschitz with respect to z, one can construct it as

$${g}_{θ}^{y} ( z , c ) = {f}_{θ} ( z , {e}_{θ}^{c} ( c ) )$$

where f_{θ} is K-Lipschitz but

$${e}_{θ}^{c}$$

is not.

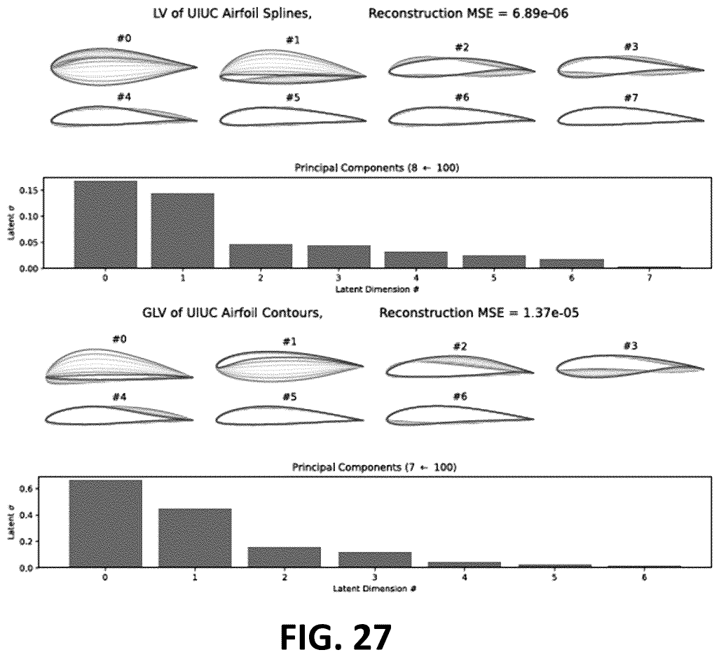

FIG. 27 illustrates LV and GLV results on UIUC airfoils, according to certain example embodiments. To illustrate the airfoil shape variation that each latent dimension controls, after obtaining the latent set's mean μ, for each latent dimension I with STD σᵢ and standard basis eᵢ, the airfoils

$${g}_{θ}^{x} ( μ + α \cdot {σ}_{i} {e}_{i} )$$

for α∈{−3, −2, −1, 0, 1, 2, 3} using hues shifting from one color (e.g., blue) to another color (e.g., red). The results illustrated in FIG. 27 indicate that GLV produces a representation distinct from that derived by the unlabeled LV. Although it is not an exact match, it may be noticeable that the latent dimension #0 and #1 of LV's result are seemingly swapped in GLV's result, suggesting that the shape variation controlled by #1 (of LV) should have more contribution to the change in lift and drag coefficient than #0. Apart from that, the GLV's dynamic pruning also manages to eliminate one or more latent dimensions than LV, although LV's last dimension can also be safely removed manually since it has marginal STD and negligible contribution to shape variation. Additionally, it can be seen that in both cases, the latent dimensions with the largest STDs in general induces the largest shape variations. This means the lift and drag coefficients are not very sensitive to shape variation (i.e., a small airfoil shape variation generally cannot induce a significant performance variation).

According to certain example embodiments, it may be possible to inspect how the overall distribution of the UIUC airfoils' latent codes changes after introducing their performance information into the LV problem. For this purpose, Procrustes Analysis may be employed to rotate, flip, and uniformly scale up the LV latent set such that it agrees as much as possible with the GLV latent set in terms of minimizing the MSE. Then the two transformed latent sets may be superimposed for comparison. In other words, the LV latent set's homogeneous transformation may be ignored and only focus on the heterogenous LV latent set transformation induced by incorporating the performance information.

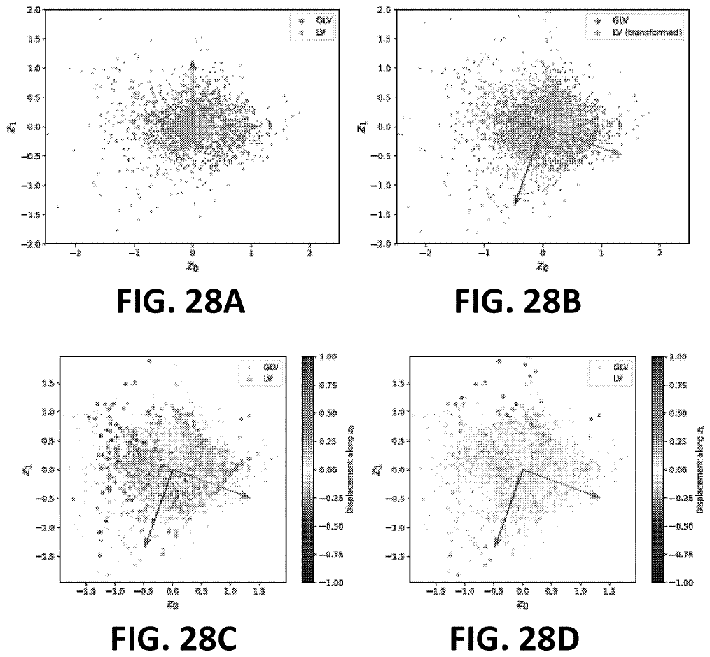

FIGS. 28A-28D illustrate an example distributions of LV and GLV latent codes of UIUC airfoils, according to certain example embodiments. FIG. 28A illustrates what the two latent sets look like before the Procrustes transformation. Here, the latent codes are projected onto the latent subspace spanned by dimensions #0 and #1. It can be seen that the LV latent set is about 3 to 4 times smaller than the GLV latent set, suggesting that the K-Lipschitz surrogate

$${g}_{θ}^{y}$$

scales up the latent set's overall length scale. This also agrees with the latent σ values in FIG. 27. FIG. 28B illustrates the two latent sets after Procrustes analysis, where the LV latent set is transformed while the GLV latent set is fixed. FIGS. 28C and 28D illustrate the displacement of the LV latent codes along dimensions #0 and #1 (of GLV). In particular, FIGS. 28C and 28D reveal the LV latent set's stretching along z₀, shrinking along z₁, and rotation in the z₀-z₁ subspace, which explains why the LV latent set's dimensions #0 and #1 look swapped in the GLV's result.

Solving the GLV problem may also derive an airfoil representation against which the lift and drag coefficients change more uniformly. Specifically, let ƒ:X×C→Y denote the airfoil performance function, and it should be expected that

$$f ( {g}_{θ}^{x} ( z ) , c ) \approx {g}_{θ}^{y} ( z , c )$$

to have more similar local (best) Lipschitz constant with respect to z∈ [symbol] everywhere. This is because

$${g}_{θ}^{y} ( z , c )$$

is constrained to be K-Lipschitz with respect to z at all c, while it also encourages not to have unnecessarily low local Lipschitz constant, as otherwise, this may stretch [symbol] and increase the volume penalty. To verify this, an inspection may be performed on the distribution of the Jacobian

$${∇}_{z} {g}_{θ}^{y} ( z , c ) ’ s$$

spectral norm

$${‖ {∇}_{z} {g}_{θ}^{y} ( z , c ) ‖}_{2}$$

at different z∈ [symbol] and c, as this equals the local Lipschitz constant when

$${g}_{θ}^{y}$$

is differentiable. Since LV does not come with the performance surrogate

$${g}_{θ}^{y}$$

in its formulation, for comparing LV's result to GLV's result, a separate surrogate may be trained to approximate ƒ(g_{θ}(z), c) for the LV decoder g_{θ}:Z→X.

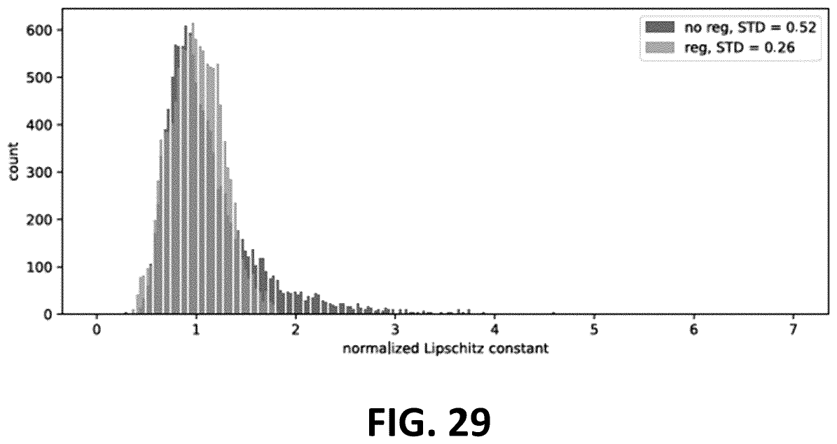

FIG. 29 illustrates an example distribution of normalized Jacobian spectral norm, or local Lipschitz constant, according to certain example embodiments. In particular, FIG. 29 illustrates the distribution of the spectral norms normalized by their median (i.e.,

$${‖ {∇}_{z} {g}_{θ}^{y} ( z , c ) ‖}_{2} / med ( {‖ {∇}_{z} {g}_{θ}^{y} ( z , c ) ‖}_{2} .$$

Thus, it can be seen that GLV has more values concentrated around 1.

In certain example embodiments, gradient-based optimization in the latent space may be optimized as intuitively, it makes the performance function ƒ less rugged with respect to z and, thus, should help stabilize the optimization. Since it is nontrivial to integrate machine learning models into conventional CFD toolkits such as XFOIL and MACH-Aero, the surrogates

$${g}_{θ}^{y} ( z , c )$$

may be used to approximately investigate this assumption.

In certain example embodiments, the airfoil may be optimized after training the LVAE on the labeled airfoil dataset. Once this is completed, the decoder g(z) of the LVAE may be a function that outputs not only the airfoil reconstruction, but also the lift and draft coefficient prediction. In certain example embodiments, when optimizing airfoils, the stochastic gradient descend may be implemented to adjust the latent code z to maximize the lift/drag ratio predicted by g(z). When z's optimization is completed, the final z* to g to generate the optimized airfoil.

According to certain example embodiments, for each of the LV and GLV AEs, given the surrogate g^{y}:z×c→y where c=a×m×r consists of AoA(a), Ma(m), and Re(r) and y=C_{L}×C_{D}, together with the specified boundary conditions m and r and drag constraint c_{d}, it may be possible to formulate the test optimization problem as follows to maximize the lift/drag ratio in the low dimensional latent space [symbol] :

$$arg {max}_{z ∈ Z , a ∈ ℝ} {C}_{L} = {g}_{y 1} ( z , a , m , r ) \qquad ( 22 )$$

$$s . t . {C}_{D} = {g}_{x}^{y} ( z , a , m , r ) = {c}_{d} . \qquad ( 23 )$$

For the case of implementation, a penalty method may be used to turn it into an unconstrained problem with Tikhonov regularization:

$$arg {max}_{z ∈ Z , a ∈ ℝ} {g}_{y 1} = {g}_{y 1} ( z , a , m , r ) + {{w}_{1} ( {g}_{y 2} ( z , a , m , r ) - {c}_{d} )}^{2} + {w}_{2} \cdot log p ( z ) , \qquad ( 24 )$$

where w₁=100, w₂=0.02, and p(z) is the probability density function of the diagonal Gaussian approximation of [symbol] , which, when combined with log, leads to a Tikhonov regularization term

$$∝ {‖ D ( z - μ ( \text{?} ) ) ‖}_{2}^{2} ,$$

where D is a diagonal matrix whose ith diagonal element equals

$${σ}_{i}^{- 1} ( \text{?} ) .$$

This log p regularization helps keep z within or at least close to Z, thus preventing z from converging to airfoil codes far away from [symbol] that correspond to invalid airfoil designs. The Adam optimizer may be employed with a learning rate of 0.01 for both LV and GLV representation. To make the learning rate equally applicable in both cases, the LV latent set may be scaled up by the scaling factor s=3.5 retrieved via Procrustes analysis, and accordingly make LV's surrogate become

$${g}_{new}^{y} ( z , a , m , r ) = {g}^{y} ( \frac{z}{s} , a , m , r ) ,$$

so that both the LV and GLV latent sets have the same length scale. For each test case (x, a, m, r, cₗ, c_{d}) drawn out of the test set, LV and GLV may be set to retrieve the airfoil x's latent codes respectively as their optimizations' initial z, and the initial values of all AoAs may be set to a to 10°. All the 1,000 test cases for 1,000 iterations may be optimized.

The optimized design variables z and a along with the corresponding airfoils retrieved by the decoder

$${g}_{θ}^{x} ( z )$$

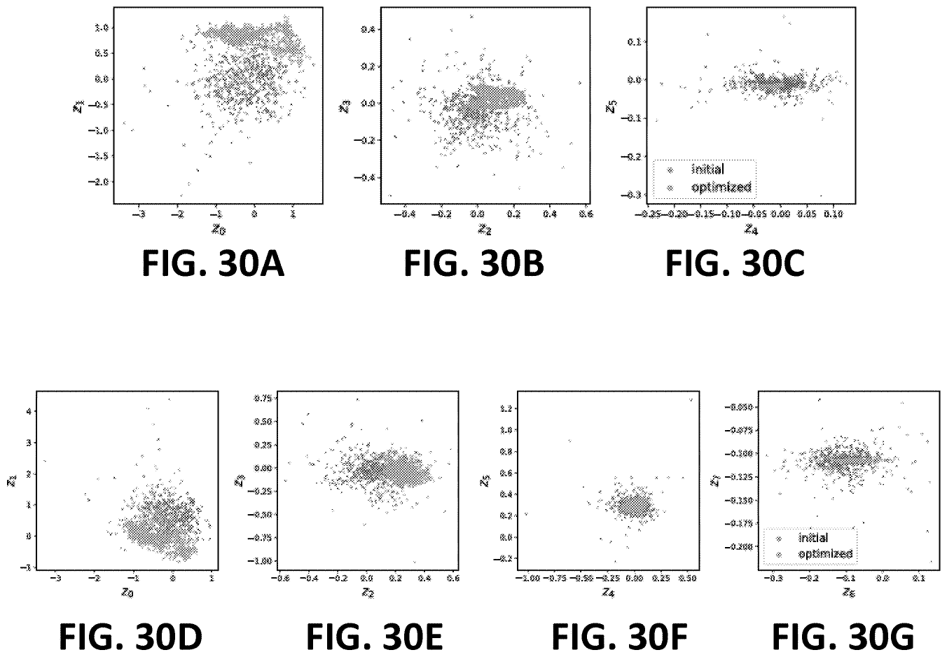

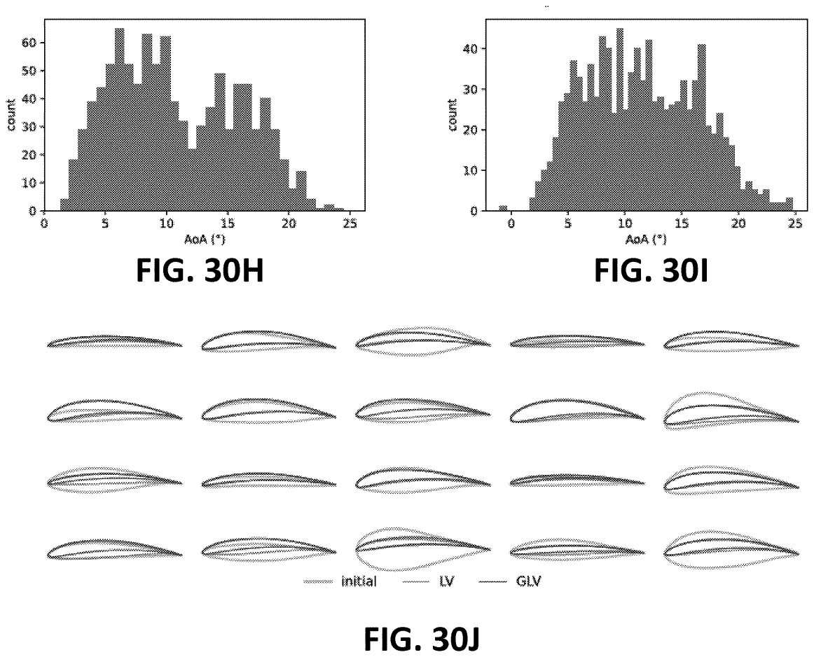

are illustrated in FIGS. 30A-30J. It can be seen from FIGS. 30A-30J that the airfoils are able to morph their shapes dramatically from the initial designs throughout the optimization. This is different in traditional airfoil optimizations without machine learning, in which the CFD optimizer usually focuses on changing the AoAs of airfoils such that the optimized shapes look similar to the initial shapes.

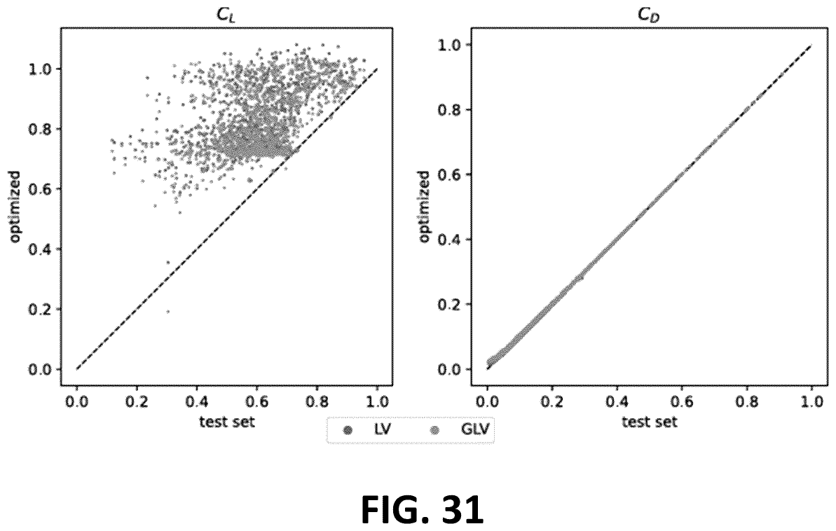

FIG. 31 illustrates an example C_{L} and C_{D} after optimization, according to certain example embodiments. As illustrated in FIG. 31, a comparison is made between the predicted C_{L} and C_{D} of optimized airfoils with the values in the test set. The comparison indicates that the optimization for both LV and GLV can improve C_{L} while having the constraint C_{D}=c_{d} satisfied.

To compare the LV and GLV design representations in terms of their influence on airfoil optimization and to determine if the GLV representation is superior in some aspects, an investigation and characterization of their optimization histories numerically may be performed (i.e., the objective's value yᵢ against the optimization iteration i).

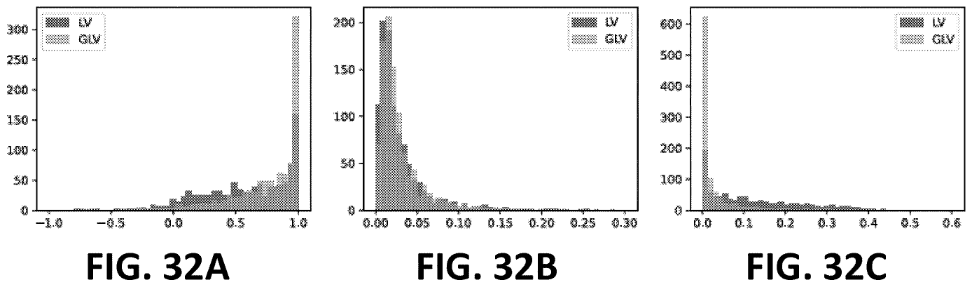

FIGS. 32A-32C illustrate example histograms of the Spearman's rank correlation, cumulative regret and mean deviation of 1,000 test cases' optimization trajectories, according to certain example embodiments. The histogram in FIG. 32A verifies that the airfoil optimizations of GLV achieve high stability as its Spearman's correlations concentrate around 1. The determination of stability may be based on whether most of the optimization curves are monotonically increasing during most iterations. This aspect may be quantified using the Spearman's rank correlation between the objective value and the iteration number. The more a curve is monotonically increasing, the closer its Spearman's correlation is to 1.

FIG. 32B illustrates that both LV and GLV have comparable cumulative regrets. As such, GLV does not bring any advantage in the convergence rate to the test cases. The convergence rate may refer to how fast the optimization converges. Additionally, the convergence rate may be quantified using cumulative regret, which is defined as

$$\frac{1}{N} {\sum }_{i = 1}^{N} ( {y}^{*} - {y}_{i} ) ,$$

where yᵢ refers to the objective value at iteration i. In other words, the cumulative regret is the average area enclosed by the optimization curve and the horizontal line at the objective value. Thus, the smaller the average area the better.

FIG. 32C illustrates that the GLV's representation can greatly improve the optimization robustness compared to LV. Here, robustness may be defines as how sensitive the optimization's final solution is to the initial guess. For instance, the same 1,000 optimization test cases may be repeated 5 times, where all the variable sand parameters are fixed each time except resampling the dataset for a different airfoil to obtain a new initial latent code z. After the optimizations 5 different resulting variables (z, a)ᵢ may be obtained for each test case. For each test case, the mean (z̅, ā) of the 5 solutions may be obtained, and then the L₂ deviation ∈ᵢ=∥(z, a)ᵢ−(z̅, ā)∥₂ may be evaluated, and finally the mean of dᵢ may be evaluated as the mean deviation to quantify how similar these 5 solutions are to each other. The distributions of these 1,000 mean deviations in FIG. 32(c) show that GLV's representation can improve the optimization robustness compared to LV. According to certain example embodiments, the integration of performance information into airfoil's LV problem may help derive a latent representation that can improve the optimization tasks' stability and robustness by making the objective function less rugged.

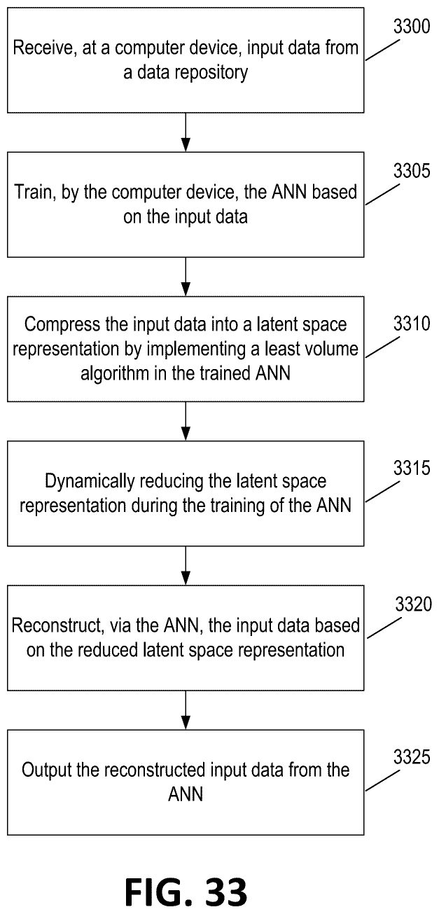

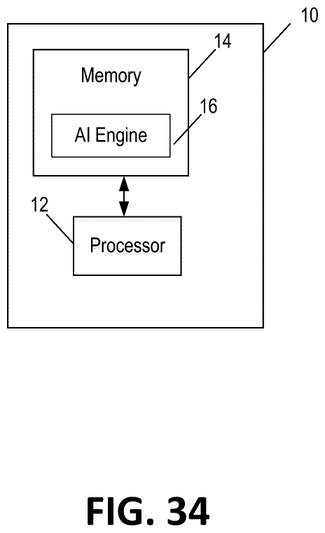

FIG. 33 illustrates an example flow diagram of a method, according to certain example embodiments. In certain example embodiments, the flow diagram of FIG. 33 may be performed by a system that includes a computer apparatus, computer system, network, an artificial intelligence (AI) engine, artificial neural network (ANN), apparatus, or other similar device(s). According to certain embodiments, each of these apparatuses of the system may be represented by, for example, an apparatus similar to apparatus 10 illustrated in FIG. 34.

According to one example embodiment, the method of FIG. 33 may include, at 3300, receiving, at a computer device, input data from a data repository. The method may also include, at 3305, training, by the computer device, the ANN based on the input data. The method may further include, at 3310, compressing the input data into a latent space representation by implementing a least volume algorithm in the trained ANN. In addition, the method may include, at 3315, dynamically reducing the latent space representation during the training of the ANN. Further, the method may include, at 3320, reconstructing, via the ANN, the input data based on the reduced latent space representation. The method may also include, at 3325, outputting the reconstructed input data from the ANN. According to certain example embodiments, the input data is reconstructed based on at least one reconstruction constraint.

According to certain example embodiments, the method may also include feeding the reduced latent space representation into the ANN for additional reduction and compression. According to some example embodiments, the method may further include searching for latent code in the latent space representation, feeding the latent code to the ANN, and generating, based on the implementation of the latent code by the ANN, a conjecture about missing data corresponding to the input data. According to certain example embodiments, the method may further include optimizing, using the ANN, the reconstruction of the input data over the latent code until reconstruction of the input data matches the missing data. According to some example embodiments, the optimization may be implemented by evaluating a gradient of a loss function of the reconstruction, and adjusting parameters of the ANN based on the evaluated gradient.

In certain example embodiments, the method may also include determining a reconstruction loss of the reconstructed input data. In some example embodiments, the reconstruction loss may be determined as a mean squared error between the input data and the reconstructed input data. In certain example embodiments, the method may further include introducing at least one categorical label into the input data that is specifically tailored for the input data.

According to certain example embodiments, the input data may include data corresponding to at least one image or at least one airfoil. According to some example embodiments, when the input data corresponds to at least one airfoil, the method may further include determining performance data of the at least one airfoil. According to certain example embodiments, the performance data may include at least lift data or drag data. According to some example embodiments, the method may also include optimizing a design of the at least one airfoil by adjusting a latent code of the at least one airfoil to maximize a lift ratio and a drag ratio of the at least one airfoil predicted by a decoder of the ANN.

FIG. 34 illustrates an apparatus 10 according to an example embodiment. Although only one apparatus is illustrated in FIG. 34, the apparatus may represent multiple apparatuses as part of a system or network. For example, in certain embodiments, apparatus 10 may be a computer apparatus that operate individually or together as a system.

In some embodiments, the functionality of any of the methods, processes, algorithms or flow charts described herein may be implemented by software and/or computer program code or portions of code stored in memory or other computer readable or tangible media, and executed by a processor.

For example, in some embodiments, apparatus 10 may include one or more processors, one or more computer-readable storage medium (for example, memory, storage, or the like), one or more radio access components (for example, a modem, a transceiver, or the like), and/or a user interface. It should be noted that one of ordinary skill in the art would understand that apparatus 10 may include components or features not shown in FIG. 34.

As illustrated in the example of FIG. 34, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 34, multiple processors may be utilized according to other embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-33.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-33.

Additionally or alternatively, in some embodiments, apparatus 10 may include an input and/or output device (I/O device). In certain embodiments, apparatus 10 may further include a user interface, such as a graphical user interface or touchscreen.

In certain embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, processor 12 and memory 14 may be included in or may form a part of processing circuitry or control circuitry.

In some example embodiments, memory 14 includes an AI engine 16. In certain example embodiments, the AI engine 16 may function as, for example, a neural network or ANN described herein (e.g., AE). The AI engine 16 may execute on a set of nodes in a distributed and/or cloud computing system to implement the functionality of apparatus 10 and/or any of the methods and examples described herein and illustrated in FIGS. 1-33. In other example embodiments, the AI engine 16 may execute on various sets of hardware, types of devices, or environments to adapt to different use cases or applications. In further example embodiments, the AI engine 16 may execute on different computing devices and/or different sets of computing devices.

According to certain example embodiments, the AI engine 16 may be loaded into memory 14 when executed, and memory 14 may include various software programs that can be executed by the AI engine 16. According to certain example embodiments, the AI engine 16 may use one or more AI model-based evaluation agents to perform the methods and examples described herein. Although only one AI engine 16 is illustrated, in other example embodiments, more than one AI engine may be present, and each AI engine may be implemented independently or collectively as an AI system.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware.

According to certain embodiments, apparatus 10 may be controlled by memory 14 and processor 12 to receive input data from a data repository. Apparatus 10 may also be controlled by memory 14 and processor 12 to train the ANN based on the input data. Apparatus 10 may further be controlled by memory 14 and processor 12 to compress the input data into a latent space representation by implementing a least volume algorithm in the trained ANN. In addition, apparatus 10 may be controlled by memory 14 and processor 12 to dynamically reduce the latent space representation during the training of the ANN. Further, apparatus 10 may be controlled by memory 14 and processor 12 to reconstruct, via the ANN, the input data based on the reduced latent space representation. Apparatus 10 may also be controlled by memory 14 and processor 12 to output the reconstructed input data from the ANN. According to certain example embodiments, the input data is reconstructed based on at least one reconstruction constraint.

Certain example embodiments may be directed to an apparatus that includes means for receiving input data from a data repository. The apparatus may also include means for training the ANN based on the input data. The apparatus may further include means for compressing the input data into a latent space representation by implementing a least volume algorithm in the trained ANN. In addition, the apparatus may include means for dynamically reducing the latent space representation during the training of the ANN. Further, the apparatus may include means for reconstructing, via the ANN, the input data based on the reduced latent space representation. The apparatus may also include means for outputting the reconstructed input data from the ANN. According to certain example embodiments, the input data may be reconstructed based on at least one reconstruction constraint.

Certain embodiments described herein provide several technical improvements, enhancements, and/or advantages. In some embodiments, it may be possible to provide a least volume technique that does not require multistage training and can utilize information content to decrease with the STD of the latent dimension instead of the latent dimension's index number. In other example embodiments, it may be possible to provide an LVAE-DP that significantly reduces the dimensions of the latent space, and possess a PCA-like effect on the latent space that makes the importance of the latent space scale with its STD. In some example embodiments, it may also be possible to provide LVAE-DP that can consistently yield comparable [symbol] ₀ and reconstruction errors for different dim Z. Certain example embodiments may also compress the latent sets into latent subspaces of lower dimensions while achieving lower reconstruction loss, and thereby improving the efficiency of LVAEs.

According to further example embodiments, it may be possible to retrieve the least dimensional latent space to alleviate the curse of dimensionality for downstream tasks, and improve the robustness of data sampling in the latent space. According to some example embodiments, it may also be possible to provide LVAE-DP that achieves great dimension reduction performance, reducing the AE's latent dimension from 4,000 to 110. Additionally, in airfoil LV problems, certain example embodiments may derive a latent representation that can improve stability and robustness of optimization tasks by making the objective function less rugged. According to certain example embodiments, implementation of GLV may provide the ability to deal with labeled datasets and incorporate label information into the latent space.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other embodiments, the functionality may be performed by hardware or circuitry included in an apparatus (e.g., apparatus 10), for example through the use of an application specific integrated circuit (ASIC), a programmable gate array (PGA), a field programmable gate array (FPGA), or any other combination of hardware and software. In yet another embodiment, the functionality may be implemented as a signal, a non-tangible means that can be carried by an electromagnetic signal downloaded from the Internet or other network.

According to an example embodiment, an apparatus, such as a device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments.

Partial Glossary:

| | |
|---|---|
| AE | Autoencoder |
| DP | Dynamic Pruning |
| GLV | Generalized Least Volume |
| IRMAE | Implicit Rank-Minimizing Autoencoder |
| LV | Least Volume |
| LVAE-DP | Least Volume Autoencoder with Dynamic Pruning |
| MNIST | Modified National Institute of Standards and Technology |
| PCA | Principal Component Analysis |
| STD | Standard Deviation |

We claim:

1. A method of using an artificial neural network (ANN) to compress a latent space, comprising:
receiving, at a computer device, input data from a data repository;
training, by the computer device, the ANN based on the input data;
compressing the input data into a latent space representation by implementing a least volume algorithm in the trained ANN;
dynamically reducing the latent space representation during the training of the ANN;
reconstructing, via the ANN, the input data based on the reduced latent space representation; and
outputting the reconstructed input data from the ANN,
wherein the input data is reconstructed based on at least one reconstruction constraint.

2. The method according to claim 1, further comprising:
feeding the reduced latent space representation into the ANN for additional reduction and compression.

3. The method according to claim 1, further comprising:
searching for latent code in the latent space representation;
feeding the latent code to the ANN; and
generating, based on the implementation of the latent code by the ANN, a conjecture about missing data corresponding to the input data.

4. The method according to claim 3, further comprising:
optimizing, using the ANN, the reconstruction of the input data over the latent code until reconstruction of the input data matches the missing data,
wherein the optimization is implemented by evaluating a gradient of a loss function of the reconstruction, and adjusting parameters of the ANN based on the evaluated gradient.

5. The method according to claim 1, further comprising:
determining a reconstruction loss of the reconstructed input data,
wherein the reconstruction loss is determined as a mean squared error between the input data and the reconstructed input data.

6. The method according to claim 1, further comprising:
introducing at least one categorical label into the input data that is specifically tailored for the input data.

7. The method according to claim 1, wherein the input data comprises data corresponding to at least one image or at least one airfoil.

8. The method according to claim 7, wherein when the input data corresponds to at least one airfoil, the method further comprises:
determining performance data of the at least one airfoil,
wherein the performance data comprises at least lift data or drag data.

9. The method according to claim 7, further comprising:
optimizing a design of the at least one airfoil by adjusting a latent code of the at least one airfoil to maximize a lift ratio and a drag ratio of the at least one airfoil predicted by a decoder of the ANN.

10. An apparatus that uses an artificial neural network (ANN) to compress a latent space, comprising:
at least one processor; and
at least one memory storing instructions which, when executed by the at least one processor, cause the apparatus to at least:
receive input data from a data repository;
train the ANN based on the input data;
compress the input data into a latent space representation by implementing a least volume algorithm in the trained ANN;
dynamically reduce the latent space representation during the training of the ANN;
reconstruct, via the ANN, the input data based on the reduced latent space representation; and
output the reconstructed input data from the ANN,
wherein the input data is reconstructed based on at least one reconstruction constraint.

11. The apparatus according to claim 10, wherein the instructions, when executed by the at least one processor, further cause the apparatus to:
feed the reduced latent space representation into the ANN for additional reduction and compression.

12. The method according to claim 10, wherein the instructions, when executed by the at least one processor, further cause the apparatus to:
search for latent code in the latent space representation;
feed the latent code to the ANN; and
generate, based on the implementation of the latent code by the ANN, a conjecture about missing data corresponding to the input data.

13. The apparatus according to claim 12, wherein the instructions, when executed by the at least one processor, further cause the apparatus to:
optimize, using the ANN, the reconstruction of the input data over the latent code until reconstruction of the input data matches the missing data,
wherein the optimization is implemented by evaluating a gradient of a loss function of the reconstruction, and adjusting parameters of the ANN based on the evaluated gradient.

14. The apparatus according to claim 10, wherein the instructions, when executed by the at least one processor, further cause the apparatus to:
determine a reconstruction loss of the reconstructed input data,
wherein the reconstruction loss is determined as a mean squared error between the input data and the reconstructed input data.

15. The apparatus according to claim 10, wherein the instructions, when executed by the at least one processor, further cause the apparatus to:
introduce at least one categorical label into the input data that is specifically tailored for the input data.

16. The apparatus according to claim 10, wherein the input data comprises data corresponding to at least one image or at least one airfoil.

17. The apparatus according to claim 16, wherein when the input data corresponds to at least one airfoil, the instructions, when executed by the at least one processor, further cause the apparatus to:
determine performance data of the at least one airfoil,
wherein the performance data comprises at least lift data or drag data.

18. The apparatus according to claim 16, wherein the instructions, when executed by the at least one processor, further cause the apparatus to:
optimize a design of the at least one airfoil by adjusting a latent code of the at least one airfoil to maximize a lift ratio and a drag ratio of the at least one airfoil predicted by a decoder of the ANN.

19. A non-transitory computer readable medium encoded with instructions that, when executed in hardware, perform a process using an artificial neural network (ANN) to compress a latent space, the process comprising:
receiving, at a computer device, input data from a data repository;
training, by the computer device, the ANN based on the input data;
compressing the input data into a latent space representation by implementing a least volume algorithm in the trained ANN;
dynamically reducing the latent space representation during the training of the ANN;
reconstructing, via the ANN, the input data based on the reduced latent space representation; and
outputting the reconstructed input data from the ANN,
wherein the input data is reconstructed based on at least one reconstruction constraint.

20. The non-transitory computer readable medium according to claim 19, wherein the process further comprises:
searching for latent code in the latent space representation;
feeding the latent code to the ANN; and
generating, based on the implementation of the latent code by the ANN, a conjecture about missing data corresponding to the input data.
